(19) United States
(12) Patent Application Publication
(10) Pub. No.: US 2026/0123646 A1
(43) Pub. Date: May 7, 2026

(54) SUSPENSIONS OF MICRONIZED EDIBLE SOLIDS IN LIPIDS, HAVING HIGH SOLID CONTENT

(71) Applicant: Omega 3 Galilee Ltd., Teradion (IL)

(72) Inventors: Alisa DUNKEL, Karmiel (IL); Ilana ROITMAN, Karmiel (IL); Shachar ASULIN, Kibbutz Ayelet HaShahar (IL); Guy BEN-ZVI, Shechania (IL); Nitzan WEINSTEIN, Haifa (IL)

(73) Assignee: Omega 3 Galilee Ltd., Teradion (IL)

(21) Appl. No.: 19/437,416

(22) Filed: Dec. 31, 2025

Related U.S. Application Data
(63) Continuation of application No. PCT/IL2025/050837, filed on Sep. 18, 2025.
(60) Provisional application No. 63/699,153, filed on Sep. 25, 2024.
(60) Provisional application No. 63/707,447, filed on Oct. 15, 2024.
(60) Provisional application No. 63/714,383, filed on Oct. 31, 2024.
(60) Provisional application No. 63/714,249, filed on Oct. 31, 2024.
(60) Provisional application No. 63/770,449, filed on Mar. 12, 2025.

(51) Int. Cl. A23G 1/00; A23G 1/02; A23P 10/35

(52) U.S. Cl. CPC A23G 1/0033; A23G 1/02; A23P 10/35

(57) ABSTRACT

Suspensions including at least 30 wt % micronized edible particles suspended in liquid lipids (e.g., oil) and their production methods are provided. Suspensions may include sugar, salt and/or spices as edible solids, as well as fine tahini pastes made of raw tahini or from seeds and/or finely-ground coffee suspension in oil. Preparation methods include mixing the edible particles in liquid lipids or paste, reducing the particle sizes in a first coarse shearing step involving size-reducing mechanical interactions between the edible particles and a shearing device, and micronizing the size-reduced edible particles suspended in the liquid lipids or paste in a second fine milling step involving size-reducing mechanical interactions among the edible particles and/or between the edible particles and a milling device. Processing aids may be added to reduce the viscosity of the suspension. Seasoned fried food products may be prepared in a single step to yield a fine and uniform coating.

### CROSS REFERENCE TO RELATED APPLICATIONS

This application is a Continuation Application of PCT Application No. PCT/IL2025/050837, International Filing Date Sep. 18, 2025, which claims the benefit of U.S. Provisional Patent Applications Nos. 63/699,153, filed Sep. 25, 2024; 63/707,447, filed Oct. 15, 2024; 63/714,249, filed Oct. 31, 2025; 63/714,383, filed Oct. 31, 2024 and 63/770,449, filed Mar. 12, 2025, all of which are incorporated herein by reference in their entireties;

### BACKGROUND OF THE INVENTION

### 1. Technical Field

The present invention relates to the field of food technology, and more particularly, to suspensions of micronized edible solids in lipids such as various oils and fats, to improving quality of seed pastes such as tahini, grape seed paste, sunflower seed paste etc., by fine milling, and to improving coffee quality by fine milling.

### 2. Discussion of Related Art

Food products are characterized by various organoleptic characteristics, such as taste, flavors, aroma, smell, texture, appearance, color, which determine the acceptability and quality of the food product.

U.S. Pat. No. 11,832,631, which is incorporated herein by reference in its entirety, discloses taste-enhanced liquid, semi-solid and/or solid oil-based suspensions, which consist of a carrier oil and edible solid particles (e.g., crystalline salt and/or sugar, and optionally spices) having median diameter of less than 15 m. The particles are reduced in size in the suspension, allowing enhancement of their organoleptic effects while reducing their amount to meet nutritional demands.

Tahini, for example, is an oily sesame-based paste, made of milled roasted sesame seeds, and used to prepare various spreads (e.g., hummus), sauces, dips, dressings and condiments (e.g., halva) and may be mixed with various ingredients. Tahini often presents significant storage challenges, such as oil separation, sedimentation and rancidity. Other seeds and nuts may also be used to prepare pastes (similar to the preparation of tahini from sesame seeds), such as sunflower seeds, grape, pumpkin, chia, flaxseed and hemp seeds, peanuts, nuts such as almonds, cashew, hazelnuts, pistachio and other spreads which suffer from the same drawbacks of separation, sedimentation, poor taste and structure loss.

Prior art fried food products are prepared generally in a two-step process, the first step including the frying of the food products by various methods, and the second steps including salting and seasoning the fried food products by various methods.

### SUMMARY OF THE INVENTION

The following is a simplified summary providing an initial understanding of the invention. The summary does not necessarily identify key elements nor limit the scope of the invention, but merely serves as an introduction to the following description.

One aspect of the present invention provides a suspension including micronized edible particles suspended in lipids, the suspension comprising at least 30 wt % micronized edible particles in the suspension.

One aspect of the present invention provides a method of preparing a suspension of at least 30 wt % micronized edible particles suspended in liquid lipids, the method comprising: mixing edible particles in oil, reducing particle sizes in a first coarse shearing step involving size-reducing mechanical interactions between the edible particles and a shearing device, and micronizing the size-reduced edible particles suspended in the liquid lipids in a second fine milling step involving size-reducing mechanical interactions among the edible particles and/or between the edible particles and a milling device.

One aspect of the present invention provides a fine seed paste made of raw seeds by one or more milling steps that reduce particle sizes and improve organoleptic characteristics of the seeds, wherein the fine seed paste has a D50 percentile of particle sizes under 15 μm or under 10 μm.

One aspect of the present invention provides a fine seed paste made of seeds by at least three milling steps comprising: a first step of reducing particles sizes from the seeds to between 150-1000 μm with optional filtering up to 500 um, a second step of reducing particles sizes from the first step to between 15-150 μm, and a third step of reducing particles sizes from the second step to around or under 15 μm or around or under 10 μm.

One aspect of the present invention provides a method of improving a quality of raw seed paste to yield fine tahini paste, the method comprising milling the raw seed paste to reduce particle sizes to reach a D50 percentile of particle diameters under 15 μm or under 10 μm.

One aspect of the present invention provides a method of preparing fine seed paste from seeds, the method comprising at least three milling steps including: a first step of reducing particles sizes from the seeds to between 150-1000 μm with optional filtering up to 500 um, a second step of reducing particles sizes from the first step to between 15-150 μm, and a third step of reducing particles sizes from the second step to around or under 15 μm or around or under 10 μm.

One aspect of the present invention provides a finely-ground coffee suspension in oil made by milling a suspension of coffee particles in the oil to reduce particle sizes to reach a D50 percentile of coffee particle sizes under 10 μm and improve organoleptic characteristics of the coffee.

One aspect of the present invention provides a method of improving coffee quality, the method comprising mixing a coffee powder in oil, to yield a suspension of coffee particles in the oil, and milling the coffee particles within the suspension to reduce particle sizes to reach a D50 percentile of coffee particle sizes under 10 μm.

One aspect of the present invention provides a method of preparing a seasoned fried food product, the method comprising frying the food product in a heated oil suspension of micronized edible particles, wherein the heated oil suspension of micronized edible particles comprises salt and/or seasoning microparticles having diameters within a range of 1-15 μm or in 1-10 μm (as the D50 percentile of the Particle Size Distribution—PSD).

One aspect of the present invention provides a fried food product coated with salt and/or seasoning microparticles having diameters within a range of 1-15 μm or in 1-10 μm (D50).

These, additional, and/or other aspects and/or advantages of the present invention are set forth in the detailed description which follows, possibly inferable from the detailed description, and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout. The patent or application file contains at least one drawing executed in color, e.g., FIGS. 4C and 5K-5M to illustrate the enhancement of color in the food products. Copies of this patent or patent application publication with color drawing(s) will be provided by the Office upon request and payment of the necessary fee. In the accompanying drawings:

FIG. 1A is a high-level schematic illustration of a non-limiting particles size reduction process and system comprising two particle size reduction steps to prepare disclosed suspensions, according to some embodiments of the invention.

FIGS. 1B and 1E are high-level schematic illustrations of three-step particles size reduction processes and systems to prepare disclosed suspensions, according to some embodiments of the invention.

FIG. 1C is a high-level schematic illustration of a production line that combines the size reduction steps with packaging machines, according to some embodiments of the invention.

FIG. 1D is a high-level schematic illustration of a continuous production line, according to some embodiments of the invention.

FIG. 1F is a high-level schematic illustration of systems for preparing oil-based suspensions, according to some embodiments of the invention.

FIGS. 2A-2C are high-level flowcharts illustrating method variants of preparing suspension of at least 30 wt % micronized edible particles suspended in liquid lipids, optionally including coffee particles, as well as preparing and refining various seed pastes, according to some embodiments of the invention.

FIGS. 3A-3L provide experimental results concerning the disclosed sugar and salt suspensions, according to some embodiments of the invention.

FIGS. 4A-4F, 5A-5M and 6A-6D provide experimental results concerning the disclosed spicy suspensions, according to some embodiments of the invention.

FIGS. 7A-7D provide experimental results that show the reduction in particle sizes and the changes in the PSD achieved by disclosed finely milling commercial raw tahini, according to some embodiments of the invention.

FIGS. 8A and 8B demonstrate in a visual manner the improvement achieved by disclosed fine milled tahini compared with commercial tahini, according to some embodiments of the invention.

FIG. 8C demonstrates in a visual manner the breaking of plant cells by disclosed milling processes, according to some embodiments of the invention.

FIGS. 9A-9C provide graphs that illustrate the improvement of multiple characteristics achieved in disclosed finely milled tahini, according to some embodiments of the invention.

FIGS. 10A and 10B demonstrate the improved organoleptic characteristics of disclosed finely milled tahini compared with commercial tahini, according to some embodiments of the invention.

FIG. 11A provides a comparison of oxidation values of commercial raw tahini and disclosed fine tahini, according to some embodiments of the invention.

FIG. 11B provides data depicting the changes in viscosity of tahini as water concentration in the mix changes, according to some embodiments of the invention.

FIG. 12 provides experimental results showing the reduction in particles sizes and the changes in the particle size distribution with successive passes through the milling step, according to some embodiments of the invention.

FIGS. 13A-13C provide images of powders, particles and premixes in oil, according to some embodiments of the invention, of three types of coffee.

FIGS. 14A and 14B provide corresponding particle size distributions (D50 and D90 percentiles, respectively) of the three types of coffee, as measured during milling the respective coffee-oil suspensions in a kitchen blender to form the respective pre-mixes, according to some embodiments of the invention.

FIG. 14C provides results of viscosity measurements at room temperature of coffee in oil pre-mix suspensions, according to some embodiments of the invention.

FIGS. 15A and 15B provide a particle size distribution and product evaluation, respectively, of cocoa mass, according to some embodiments of the invention.

FIGS. 16A and 16B provide assessments of enhanced sweetness in products including milled sugar as disclosed herein, according to some embodiments of the invention.

FIG. 16C provides assessments of enhanced saltiness in products including milled salt as disclosed herein, according to some embodiments of the invention.

FIGS. 16D and 16E provide temperature-dependent viscosity measurements of disclosed suspensions of milled salt and of milled spices, respectively, according to some embodiments of the invention.

FIGS. 17A and 17B present a high-level flowchart and a schematic diagram, respectively, illustrating methods of preparing a seasoned fried food product, according to some embodiments of the invention.

FIG. 18 provides an experimental comparison of mixing salt in oil and frying French fries therein, according to some embodiments of the invention.

FIG. 19 illustrates the suspendability of the micronized salt particles in the oil suspension, according to some embodiments of the invention, compared to prior art table salt that cannot be suspended in oil.

FIGS. 20A-20C provide comparative results concerning various organoleptic characteristics of French fries prepared by the disclosed methods, according to some embodiments of the invention, compared with prior art French fries and alternative preparation methods.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention may be practiced without the specific details presented herein. Furthermore, well-known features may have been omitted or simplified in order not to obscure the present invention. With specific reference to the drawings, it is stressed that the particulars shown are by way of example and for purposes of illustrative discussion of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein are for the purpose of description and should not be regarded as limiting.

Some embodiments of the present invention provide efficient and economical methods and mechanisms for producing lipid suspensions of micronized edible particles for various food applications, and thereby provide improvements to the technological field of food preparation. Suspensions including at least 30 wt % micronized edible particles suspended in lipids and their production methods are provided. Suspensions may include sugar, salt and/or spices, and optionally monosodium glutamate, citric acid, rice flour, fibers, cocoa powder, coffee powder, dried vegetables and fruits powders like onion powder or lemon powder, milk powder, protein flours (like soy flour) or any other edible solids which are not miscible in lipids—micronized in two consecutive milling stages within the carrier liquid lipids to sizes of a few microns that significantly increase their taste effects. Including sugar, salt and/or spices, and/or other types of oil-immiscible edible solids in the lipids also improves and simplifies various food production process. Preparation methods include mixing the edible particles in liquid lipids, reducing the particle sizes in a first coarse shearing step involving size-reducing mechanical interactions between the edible particles and a shearing device, and micronizing the size-reduced edible particles suspended in the liquid lipids in a second fine milling step involving size-reducing mechanical interactions among the edible particles and/or between the edible particles and a milling device. Food additives such as processing aids, emulsifiers or other stabilizers may be added as a processing aid, to reduce the viscosity of the suspension as well as to improve the stability, homogeneity, and rheology of the suspension during the process as well as to extend its shelf life.

Some embodiments of the present invention provide efficient and economical methods and mechanisms for producing fine tahini with improved organoleptic traits, and thereby provide improvements to the technological field of food quality. In various embodiments, seeds other than sesame and/or nuts may be used to form corresponding seed pastes. Non limiting examples for seeds and/or nuts that may be processed as disclosed herein include, e.g., sesame seeds, sunflower seeds, pumpkin seeds, grape seeds, watermelon seeds, chia, flaxseed and hemp seeds, as well as coffee and cocoa beans and pine nuts, and various types of nuts, such as, e.g., peanuts, almonds, hazelnuts, pistachios, cashews, walnuts, pecan nuts, Brazil nuts, macadamia, etc. Various embodiments provide refined, finely-milled pastes made of any of various seeds or nuts, reaching median particle sizes below 15 μm or below 10 μm—enhancing the physical, chemical and organoleptic properties of the pastes compared to commercial pastes. Disclosed embodiments may be applied to any type of seeds or nuts, which enable wet-milling, e.g., having a fat/oil content of at least 30%.

Some embodiments of the present invention provide efficient and economical methods and mechanisms for producing finely-ground coffee with improved organoleptic traits, and thereby provide improvements to the technological field of food quality. Finely-ground coffee suspensions in oil are disclosed, which are made by milling a suspension of coffee particles in the oil to reduce particle sizes to reach a D50 percentile of coffee particle sizes under 10 μm and improve organoleptic characteristics of the coffee. In some embodiments, the coffee particles in the finely-ground coffee suspension may have a D10 percentile of particle sizes under 5 μm and/or a D90 percentile of particle sizes under 20 μm. The finely-ground coffee suspension may have improved taste compared to commercial ground coffee—such as the coffee powder used to form the initial suspension, before the particle size reduction. In some embodiments, the oil used to form the suspension may include MCT (medium-chain triglyceride) oil. Milling methods include reducing particle sizes in a shearing step involving size-reducing mechanical interactions between the particles and a shearing device, and micronizing the size-reduced particles suspended in the oil in a milling step involving size-reducing mechanical interactions among the particles and/or between the particles and a milling device.

Disclosed embodiments comprise suspensions of microparticles of edible solids which are not miscible in lipids or have limited suspendability (the ability of the dispersed particles to remain stably distributed throughout the suspension) in oil (e.g., crystalline sugar and/or crystalline salt, spice particles, vanilla, monosodium glutamate, rice flour, fibers, cocoa powder, coffee powder, dried vegetables and fruits powders as onion powder or lemon powder, milk powder, proteins flour e.g., soy flour, etc.) in the liquid lipids, e.g., in a carrier oil (such as MCT—Medium Chain Triglyceride oil). The fine micronization (particle size reduction to a few microns, e.g., D50 percentile between 1-15 μm, with a narrow size distribution) of the edible particles enhances their taste and releases different taste and aroma compounds—so that more taste can be achieved with less amount of respective edible particles, and moreover enables application to the edible solids together with the oil component in various food products, improving their organoleptic properties and simplifying the production processes in multiple applications. For example, less sugar and/or less salt may be used in food products while generating similar or even higher sweetness and/or saltiness, respectively, sugar, salt and/or spices may be applied together with lipids in various processed foods, etc.

Lipids include various fatty compounds, compounds including fatty acids and related compounds. For example, lipids include various fatty acyls (fatty acids and their conjugates and derivatives), glycerolipids comprising a glycerol backbone with one, two or three fatty acids substituting respective hydroxyl groups, phospholipids comprising a glycerol backbone with two fatty acids substituting respective hydroxyl groups and a third phosphate-containing group substituting the third hydroxyl group and related compounds. Lipids are further understood herein to include various types of fatty acid esters, including mono-, di- and triglycerides as well as fatty acid esters of alcohols other than glycerol (e.g., ethanol forming ethyl fatty acid esters). It is noted that lipids include various edible oils and fats (which may be used in liquid phase to carry the edible particles through their micronization process)—that are typically triglycerides, as well as ethyl esters derived from triglycerides, e.g., during food processing.

The application of sugar, salt and/or spices in the oil (lipid) phase rather than separately or in the water phase (depending on the type of food product) further provides organoleptic and industrial improvements and advantages, as well as logistic simplifications through the combination of two or more ingredients into one. In various embodiments, disclosed suspensions include at least 30 wt % micronized edible particles suspended in lipids, and possibly between 40 wt % and 75 wt % micronized edible particles in the suspension. The range of possible concentrations of the edible solids in lipids is broad and may be configured to correspond to the specifications of the respective food products such as sugar and salt content, and lipids content; as well as to logistic considerations, as concentrated suspensions may be diluted in additional lipids, e.g., in additional oil.

In certain embodiments, some or all of the edible solid microparticles may be dried before mixing with the liquid lipids, to remove humidity that may reduce the quality of the suspension, and/or may increase the viscosity of the fine milling step (see below).

Examples of food products include fat-based phase applications such as filling cream for baked goods or spreads, typically including 30 wt % fat of the total product mass. Disclosed micronized sugar in lipids suspensions may include 40 wt %, 50 wt %, 60 wt % sugar or more to reach total sugar content of 20-50 wt % in the food product, at the prescribed high fat content.

Examples of food products further include fat-based spreads such as tahini and peanut butter, savory fat-based condiments, as well as fat-based confections such as halva, liquid chocolate, fudges, etc. For example, disclosed food products comprise fat-based creams and spreads that may be prepared as spreads containing disclosed suspensions having 30-75 wt % sugar in oil or fat—for example, cocoa hazelnut spread, halva and spreads thereof, milk/white chocolate and spreads thereof, pistachio spreads—as well as filling creams for waffles of various types (e.g., chocolate, vanilla, hazelnut, lemon, etc.) and cakes and pies of various types (e.g., chocolate, cinnamon, almond cream, etc.). Disclosed food products made with disclosed suspensions may also comprise cookies, bars, various bakery products (e.g., croissants, various pastries etc.). Disclosed food products may also comprise emulsions such as ice creams, and creams that are based on milk or on heavy cream (e.g., Ganache, pastry cream)—which may contain suspensions having 40-75 wt % sugar. Disclosed food products made with disclosed suspensions may also comprise solid chocolate in various forms, containing suspensions which may include 30-75 wt % sugar in cocoa butter or cocoa mass for coating (e.g., of confectionery, ice creams, chocolate bars, cookies, etc.) and filling (e.g., in bakery products, ice creams, chocolate bars, etc.), as well as biscuits and cookies that contain suspensions which may include 40-75 wt % sugar in oil and/or fat or 40-75 wt % cocoa solids (powder or mass) in cocoa butter. In some embodiments, the suspension may be diluted in oil to reach a concentration of micronized edible particles in the suspension of 30 wt % or less.

Examples of food products further include various types of emulsions (e.g., ice cream), that contain a relatively a low percentage of fat in relation to the percentage of solids in the system. Disclosed micronized sugar in lipids suspensions may include higher sugar content, e.g., 40 wt %, 50 wt % or more in the suspension, to reach the required amount of sugar in the food product (e.g., 10 wt %, 15 wt % sugar or any other specified amounts), due to the lower amount of total fat (e.g., 5 wt %, 10 wt %, 15 wt % fat or any other specified amount, in relation to sugar concentration in the suspension).

Examples of food products further include various types of baked goods (e.g., cookies that contain a relatively high percentage of fat). Disclosed micronized sugar in cookies' suspensions may include higher sugar content, e.g., 40 wt %, 50 wt % or more in the suspension, to reach the required amount of sugar in the food product (e.g., 5 wt %, 10 wt %, 15%, 30% sugar or any other specified amounts), with respect to the type of the cookie and required composition, in relation to sugar concentration in the suspension.

Examples of food products further include coating applications such as savory snacks, which are traditionally carried out by spraying oil and then sprinkling salt and spices onto the snack or alternatively spraying of unstable oil-solid slurries (oil mixed with large particles, having sizes of tens or hundreds of microns). Both traditional methods require multiple steps in production and result in a rough, thick and non-homogenous distribution of solid particles on the food. Disclosed suspensions may include micronized salt, spices and optionally sugar in liquid lipids such as oil, that can be applied directly to the snacks, turning the current two-stage processes into a single stage process, which is both simpler and results in a more even distribution of the micronized salt, spices and optionally sugar. Disclosed suspensions may comprise micronized salt and spice particles at specified ratio that ensures that the snack is not too oily or fatty, and that the spice and salt adhere to the snack sufficiently without affecting the consumer experience.

Non-limiting examples for savory snacks include salted or spiced nuts and seeds (with or without shells), such as pistachio, peanuts, sunflower seeds, pecans, cashews, almonds, peanuts, etc., as well as snacks such as potato chips, various extruded snacks (made of proteins and starches), crackers, flat pretzels, etc. Any of these savory snacks may comprise suspensions which may include 30-75 wt % edible solids such as salt, monosodium glutamate, and/or spices. The suspensions may be sprayed to form the savory snacks, applying both oil and salt and/or spices in the same application, and possibly reducing the amount of respective salt and/or spices required to yield specified organoleptic characteristics (e.g., taste intensity) and improving the uniformity and fineness of dispersal of the salt and/or spices. Moreover, spices may have extended shelf life when suspended in liquid lipids (e.g., oil) compared to dry storing, and less or no additives (e.g., starches, stabilizers, preservatives) may be required to the spices—further concentrating the spices and improving their use efficiency even beyond the fine grinding to micronized size in suspension. In various embodiments crystalline sugar too may be included in the edible particles used for suspensions for savory snacks. For example, in non-limiting embodiments, Table 1 provides a list of savory snacks and the extent of reduction that can be achieved in the amount of sodium (Na) using disclosed suspensions and production methods. The sodium amounts listed are after the reduction (compared with commercial products).

TABLE 1
Savory snacks and sodium reduction.

| | | Reduction | Sodium amount, |
|---|---|---|---|
| | | in sodium | after the reduction |
| Savory snack | Example product | level | (mg/ 100 gr) |
| Nuts | Peanuts | −65% | 390 |
| | Cashews | −50% | 250 |
| | Pecans | −50% | 350 |
| | Almonds | −42% | 340 |
| Shell nuts/ | Pistachio | −50% | 700 |
| seeds | Sunflower seeds | −75% | 700 |
| Snacks | Potato chips | −50% | 300 |
| | Protein extrusion | −33% | 400 |
| | product | | |
| Dough snacks | Flat pretzel | −50% | 250 |
| | Crackers | −50% | 200 |

In various embodiments, the following examples for edible solid particles (or combinations of solid particles and fat) were used and milled in the oil suspension, reaching between 15-75 wt % of the solids from the suspension: White crystalline sugar, Demerara crystalline sugar, fibers, rice flour, various protein powders, cocoa powder, crystalline salt (NaCl), oregano, coriander seeds, chicory root fibers or any other fibers, vanilla and/or cocoa. Additional examples for edible solids which are not miscible in oil or have limited suspendability (referring to the stability of the particles in the suspension) in oil include spice particles, monosodium glutamate, milk powder, proteins flour such as soy flour, etc.

The types of oils used for the suspensions included the following: Cocoa butter, MCT oil, Ghee butter, palm oil, high olein palm oil, hazelnut paste, milk butter, milk fat, refined coconut oil, sunflower oil, canola oil, soy oil (all in liquid phase, melted if needed) or animal fats like tallow, lard, duck fat, chicken fat etc. in their molten liquid form. The food products may further include additives such as flavors and processing aids (e.g., lecithin, monoglycerides, MDG—mono- and diglycerides, PGPR—polyglycerol polyricinoleate, arabic gum, etc.). As disclosed herein, many other types of lipids in liquid form may be used to form the suspensions and mill the edible particles therein.

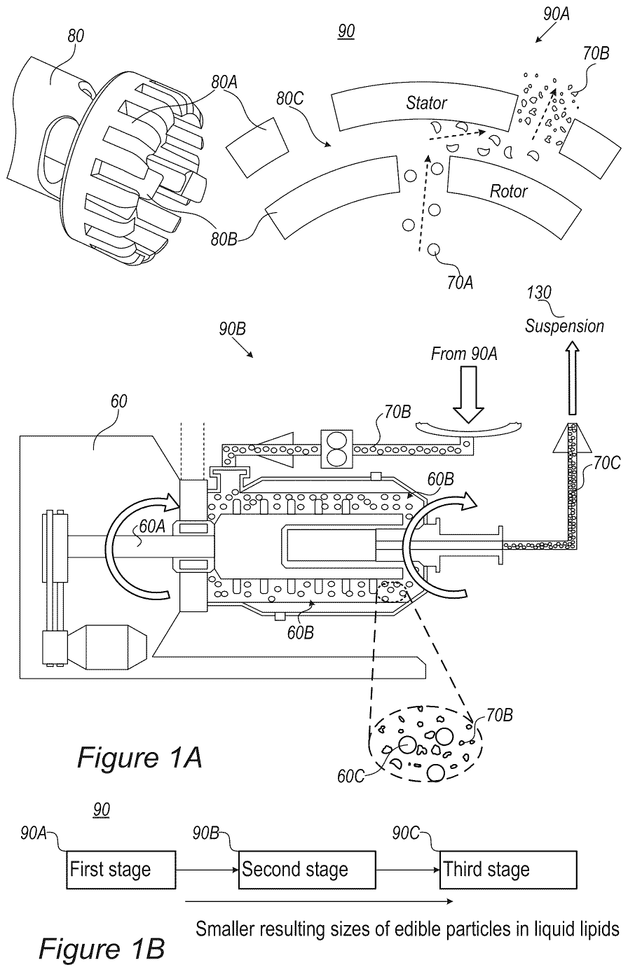

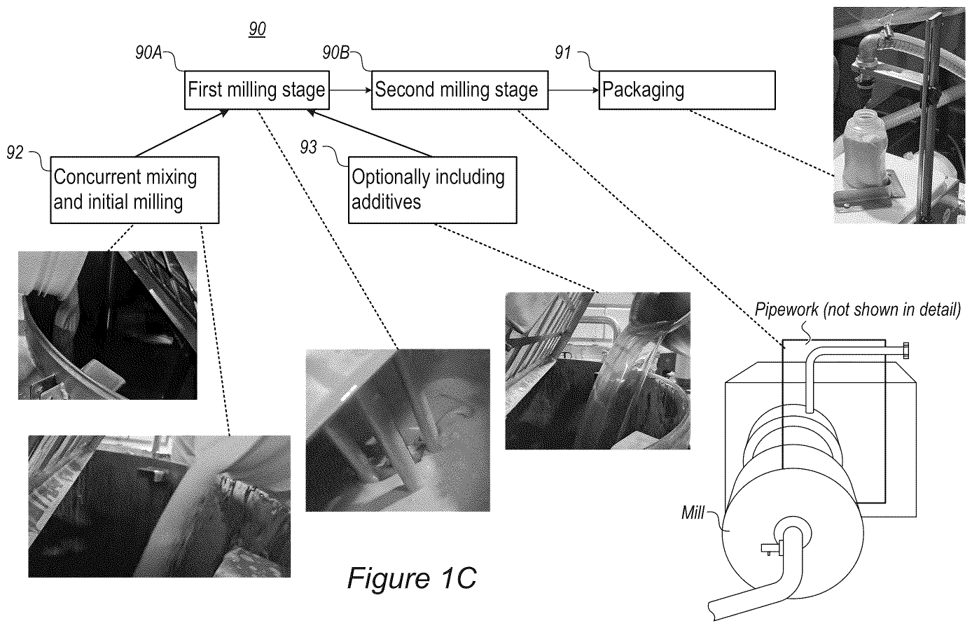

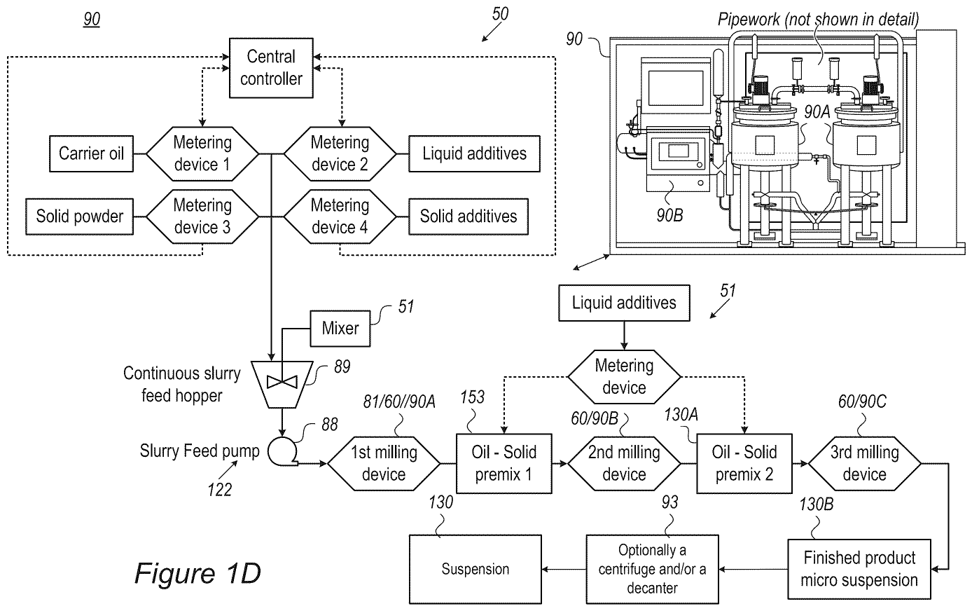

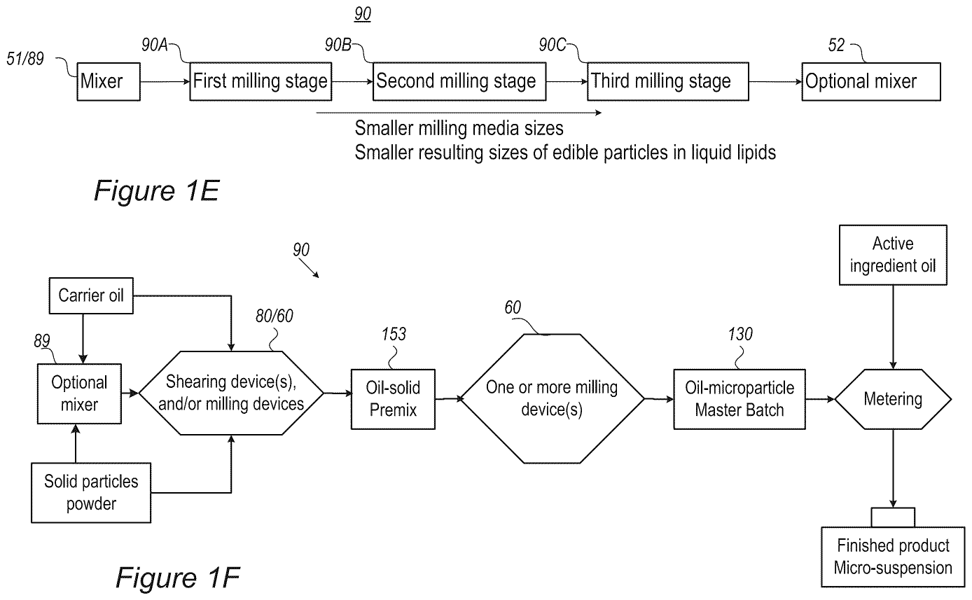

FIG. 1A is a high-level schematic illustration of a non-limiting particles size reduction process and system 90 comprising two particle size reduction steps 90A, 90B to prepare disclosed suspensions 130, according to some embodiments of the invention. FIGS. 1B and 1E are high-level schematic illustrations of three-step particles size reduction processes and systems 90 to prepare disclosed suspensions, according to some embodiments of the invention.

As illustrated schematically and in a non-limiting manner in FIG. 1A, first particle size reduction step 90A may comprise a coarse shearing step involving size-reducing mechanical interactions between solid particles 70A (e.g., crystalline sugar, crystalline salt, various spice particles, etc.) and a shearing device 80, e.g., comprising a rotor 80B rotating with respect to a stator 80A, with a shearing gap 80C in-between, into which an initial suspension of solid particles 70A in oil (as a non-limiting example for liquid lipids) is introduced and in which particle size is reduced to yield solid particles 70B. Non-limiting examples for shearing devices 80 comprise a high shear mechanical mixer and/or a homogenizer with a rotor and a stator.

Second particle size reduction step 90B may comprise a fine milling step involving size-reducing mechanical interactions among solid particles 70B (following initial particle size reduction step 90A) and/or between solid particles 70B and a milling device 60, e.g., comprising a rotating shaft 60A, delivering rotation into a milling chamber 60B with milling media 60C, in which particles 70B collide and their sizes are reduced to yield disclosed suspensions with micronized particles 70C (illustrated in a highly schematic manner). Non-limiting examples for milling devices 60 comprise a high-pressure high-shear microfluidizer and/or a horizontal ball mill (having small milling media 60C, e.g., particles smaller than 1 mm, possibly a few hundred microns or a few tens of microns in diameter). The size of milling media 60C may be adjusted to the types of the particles and the oil, as well as to particle sizes.

In various embodiments, the particles may include various solid particles that are significantly denser than water, e.g., having a density between 2 and 4 gr/ml (e.g., crystalline salt at about 2.2 gr/ml, and even inedible fillers such as calcium carbonate at about 2.7 gr/ml and magnesium oxide reaching 3.6 gr/ml, in some implementations).

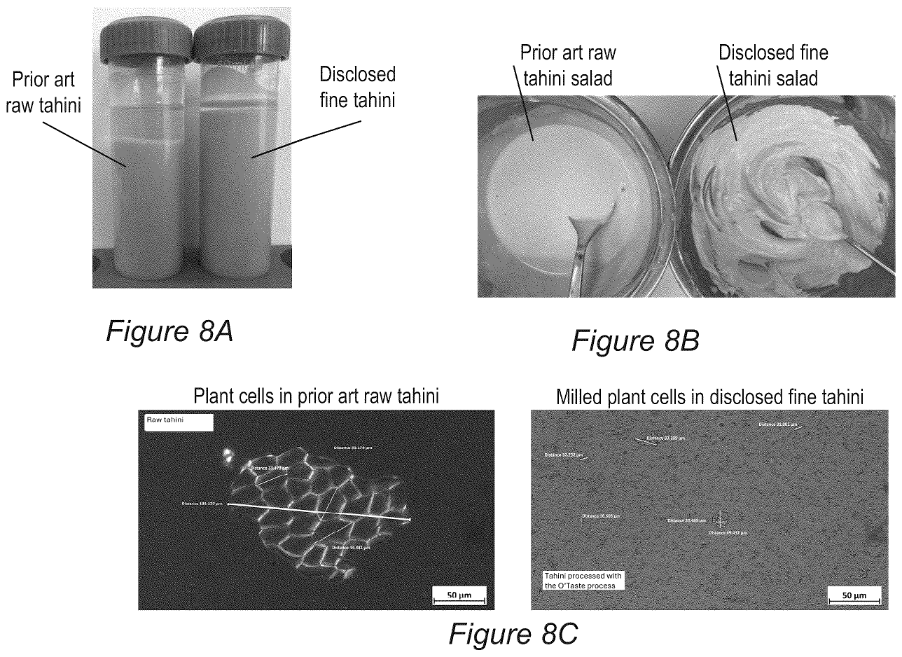

In some embodiments, the particles may include various ductile, softer materials, such as spice particles and plant products. The disclosed particle size reduction was shown to enhance taste and color properties of ductile, softer material particles (see, e.g., herein concerning spices, seed pastes and tahini, coffee and cocoa, etc.). The inventors have found out that disclosed milling processes break cells of ductile plant materials (see, e.g., FIG. 8C), releasing taste and color components which are not available using prior art methods, and are not even made available by chewing the respective food stuffs. As a consequence, disclosed milling processes enhance significantly the taste and color provided using plant materials, and/or enable reducing the amount of the respective material to achieve a similar level of taste and color compared with the prior art. Enhancement of taste and/or color was demonstrated for spices (e.g., paprika and spice mixtures, coffee, cocoa and sesame.

As illustrated schematically in FIG. 1B, in some embodiments particles size reduction process 90 may comprise three or more particle size reduction stages 90A, 90B, 90C, e.g., each reducing the median particle size (D50) by a factor of about 10 (possibly between 5 and 10). For example, stage 90A may comprise a shearing stage and stages 90B, 90C may comprise one, two or more ball milling stages with different milling media 60C (e.g., ball) sizes. In another example, all stages 90A, 90B and optionally one or more stage 90C may comprise milling stages, e.g., multiple ball milling stages. In some embodiments, multiple ball milling stages may be operated in a continuous cascade mode to provide initial particle size reduction step 90A (e.g., with large milling media), to provide second particle size reduction step 90B (e.g., with smaller milling media), and optionally to provide additional one or more size reduction step(s) 90C.

Increasing the concentration of solids in the suspension increases the viscosity of the suspension. The inventors have reached sugar concentrations of 35-75 wt % while maintaining the required rheology properties that enable the multi-step milling processes described in FIGS. 1A and 1B, e.g., less than 10,000 cP at 25° C.

In various embodiments, particle size reduction stages may employ various machines, e.g., machines 80 for rough shearing such as rotor-stator, high-shear mills, colloid mills, conical mills; and machines 60 for fine milling such as bead mills and attritors using milling media (e.g., ball mills, continuous attrition mills), high-pressure wet mills that force the suspension through narrow chambers, causing intense particle collision and size reduction, and immersion mills in which the milling chamber is immersed directly in the suspension.

FIG. 1C is a high-level schematic illustration of a production line that combines the size reduction steps with packaging machines, according to some embodiments of the invention. In a non-limiting example, images are provided for preparation stages of refined peanut butter (milling machine illustrated schematically). The refining is similar to the refining of tahini or other seed pastes described below. Similar production lines may be configured to produce various chocolate products and spreads, peanut butter spreads, various syrups like maple, chocolate or other syrups.

In various embodiments, seed pastes disclosed herein may be processed in a similar manner, as well as seasoned oils, salty and spicy seed pastes (e.g., seasoned tahini or peanut butter), and various oil-based dressings sauces. Examples that were prepared on experimental scale also include oil-based teriyaki and other Asian sauces, vinaigrette dressing, sriracha sauce, flavored olive oil that includes lemon, garlic, oregano, etc., sweet syrups such as cocoa-hazelnut, peanut butter, caramel cookies based on coconut sugar, garlic-lemon tahini and spicy Asian-style tahini. In various embodiments, combinations of similar ingredients may be used to produce any specific recipe.

As illustrated, first particle size reduction stage 90A may incorporate the mixing of some or all of the ingredients 92 (e.g., illustrated peanut butter and sugar) carried out in shearing device 80 (optionally without using a dedicated mixer) as well as optional mixing of additives 93 (see herein, e.g., emulsifiers) during the first particle size reduction stage 90A. Following the transfer of the suspension to second particle size reduction stage 90B (e.g., a mill), the processed suspension may be directly packaged 93.

Implementing one stage for mixing and particle size reduction, following by fine milling, provides a continuous process 90 that allows small amounts of material to be processed and packaged (e.g., at a rate of 100 kg/hr) to achieve a similar total throughput as prior art large batch processes that require much longer processing durations (e.g., 4 ton batches processed for 48 hours yield averaged 83 kg/hr). In addition, the smaller scale continuous process requires a much smaller physical footprint (as the machines are smaller, and there is no need for intermediate containers to handle the large batches) and consumes much less energy. Moreover, continuous processing with direct packaging provides better hygiene and control, as any errors may be fixed quickly and do not require disposal of the whole batch. Such small continuous processes 90 differ from large scale batch processes and provide the quantitative benefits of reduced footprint, cost and energy consumption, and qualitative benefits of enhanced hygiene and operational flexibility.

FIG. 1D is a high-level schematic illustration of a continuous production line, according to some embodiments of the invention. In some embodiments system 90 may be configured as a continuous production line including a continuous feed system 50 for various raw material channels (e.g., carrier oil, solid particles, optionally liquid and/or solid additives) based on continuous weight or volumetric dosing systems synchronized to provide a constant continuous ratio of components. A schematic illustration of implemented system 90 is provided, with most of the pipework (conduits, pumps, meters, valves, etc.) not shown to maintain clarity. For example, one feed line may provide the carrier oil, another feed line may provide solids like crystalline sugar or salt and another feed line may provide other additives like spices, processing aids, emulsifiers (e.g., lecithin, mono- and di-glycerides, polyglycerol polyricinoleate (PGPR), etc.). The use of continuous feeding may simplify and streamline the system by eliminating the need for a batch premix process. Additional continuous feed lines may be added as required.

In some embodiments system 90 may be configured as a continuous production line, including shearing device(s) 80 receiving an initial mixture 122, or possibly receiving directly the carrier oil and the particles, and reducing the sizes of the particles to create premix 153, milling device(s) 60 that further reduce particle sizes as disclosed herein to yield suspension 130, and additional metering and optionally mixing devices that may dilute or concentrate suspension 130 and/or mix suspension 130 with oil-based products to yield the final product.

In some embodiments, system 90 for preparing an oil-based suspension comprises shearing device(s) 80 or milling device(s) 60 implementing first milling stage 90A and configured to reduce a particle size of crystalline particles within a mixture thereof with a carrier liquid oil to a median particle size of between 15-150 μm, yielding an oil-solids pre-mixture 153, and further implementing second milling stage 90B and optionally third milling stage 90B, and configured to reduce a particle size of the crystalline particles within the carrier liquid oil in the oil-solids pre-mixture to a median particle size of between 0.1-15 μm to yield a taste-enhanced liquid oil-based suspension 130A or 130B (when only second milling device 60 or both second and third milling devices 60 are used, respectively) comprising the carrier liquid oil and crystalline particles having median diameter of between 0.1 μm and 15 μm. All reduction steps are carried out on the particles within the carrier liquid oil, and the taste-enhanced liquid oil-based suspension 130A and/or 130B provides enhanced taste relative to the mixture comprising the same weight percentage of particles (e.g., prior to first milling step 90A).

System 90 may further comprise mixer (or other mixing device) 51 configured to mix the crystalline particles with the carrier liquid oil and optionally solid and/or liquid additives to yield initial mixture 122 comprising the crystalline particles in the carrier liquid oil, which is delivered to shearing device 80 or milling device 60 at first milling stage 90A.

In various configurations, first milling stage 90A may comprise first milling device 60 and second and optionally third milling stages 90B, 90C may comprise corresponding second milling device 60 and optionally third milling device 60, wherein consecutive milling devices 60 include milling media 60C (see FIG. 1A) of decreasing sizes. For example, milling media 60C of decreasing sizes include milling media 60C having a size smaller than 2 mm in first milling device 60 (used in stage 90A) and milling media having a size smaller than 1 mm or 1.5 mm in second and optionally third milling device 60C (used in stages 90B and optionally 90C).

In various embodiments, the volume percentage of the milling media may be optimized with respect to particle sizes, e.g., the milling media in different stages may occupy between 50 vol % and 90 vol %, between 70 vol % and 85 vol %, between 70 vol % and 75 vol %, between 75 vol % and 85 vol %, or intermediate values, depending on the type of the milling device, the milling stage, the types of particles and their sizes.

In various configurations, system 90 may be configured to process the mixture and yield taste-enhanced liquid oil-based suspension 130 (or 130B) in a continuous manner. Advantageously, such configurations simplify the production line by avoiding an initial batch preparation of initial mixture 122 of the carried oil and the crystalline particles. For example, as illustrated schematically in FIG. 1D, continuous slurry feed hopper 89 may receive the mixture and/or ingredient from mixer 51 and a slurry feed pump 88 may operate continuously to deliver the mixture to shearing device 80 or milling device 60 of first milling stage 90A.

In some embodiments, system 90 may further comprise at least one mixer (or other mixing device) 51 configured to mix additional liquid into oil-solids pre-mixture 153 or possibly initial suspension 130A between two milling devices 60 (e.g., milling devices of stages 90A, 90B and/or milling devices of stages 90B, 90C, respectively). In some embodiment some components may be added in between two continuous milling devices, for example taste concentrates, colorants or fragrance additives or other components which do not require the first or second milling steps because they are already fine enough or too sensitive to withstand the full process.

In some embodiments, system 90 may comprise three milling steps (90A, 90B, 90C) each reducing the average particle size by a factor of 5-10 and thus achieving a 100-1000 fold decrease in average particle size allowing to begin with large mm size particles and in one process achieving um size particles.

Advantageously, the configuration of disclosed systems 90 as a continuous production line, enable maintaining the production process continuous (rather than typical prior art batch process), anaerobic or less aerobic than prior art processes, and devoid of water to a considerable extent, which reduce the degree of unwanted oxidation, in spite of the relatively high working temperatures, and provides safer products with reduced contamination risks. Moreover, the continuous process simplifies further processing of the suspensions and products in a heated soft liquid or semi liquid state.

Increasing the concentration of solids in the suspension increases the viscosity of the suspension. The inventors have reached sugar concentrations of 35-65 wt % and optionally even as high as 80 wt % while maintaining the required rheology properties that enable the multi-step milling processes described in FIGS. 1A and 1E, e.g., less than 10,000 cP at 25° C. In some embodiments, the concentration of suspension 130B may be increased (e.g., from between 20-40 wt % to between 50-80 wt % of the size-reduced crystalline particles).

As illustrated schematically in FIG. 1E, in some embodiments system 90 may implement particles size reduction processes that comprise three or more milling stages 90A, 90B, 90C by milling device 60, e.g., each reducing the median particle size (D50) by a factor of about 10 (possibly between 5 and 10). For example, stages 90A, 90B, 90C may comprise multiple ball milling stages with different milling media 60C (e.g., ball) sizes. In some embodiments, multiple ball milling stages by milling device 60 may be operated in a continuous cascade mode to provide alternative initial particle size reduction step 90A (e.g., with large milling media), provide second particle size reduction step 90B and optionally provide additional one or more size reduction step(s) 90C.

As further illustrated schematically in FIG. 1E, system 90 may comprise mixing device 89 configured to mix crystalline particles with a carrier liquid oil to yield an initial mixture 122 and optionally another mixer (or other mixing device) 52 configured to mix suspension 130 with an additional oil or product with a high-oil content, to provide a final taste-enhanced product (e.g., sweetened or salty), and/or to mix suspension 130 with an oil-based food product.

FIG. 1F is a high-level schematic illustration of systems for preparing oil-based suspensions, according to some embodiments of the invention. As illustrated schematically in FIG. 1F, in some embodiments system 90 may be configured as a continuous production line, including shearing device(s) 80 receiving initial mixture 122, or possibly receiving directly the carrier oil and the particles, and reducing the sizes of the particles to create premix 153, milling device(s) 60 that further reduce particle sizes as disclosed herein to yield suspension 130, and additional metering and optionally mixing devices that may dilute or concentrate suspension 130 and/or mix suspension 130 with oil-based products to yield the final product.

In some embodiments, the concentration of the particles may be further increased using a centrifuge and/or a decanter 93 to yield an even more concentrated suspension 130. In some embodiments, suspensions 130B may already include, e.g., 60 wt %, 70 wt %, 80 wt % or intermediate percentages of solids and not require further concentration.

In certain embodiments, processing aid(s) and/or emulsifier(s) such as lecithin (E322), monoglycerides, mono- and diglycerides (MDG, E471), polyglycerol polyricinoleate (PGPR, E476), sodium stearoyl lactylate (SSL, E481) and arabic gum were used to reach higher concentrations of micronized edible particles in the suspension, e.g., between 40 wt % and 75 wt %. It is noted that while emulsifiers are typically used in the food industry to mix immiscible liquids, typically a water phase and an oil phase, in disclosed embodiments, emulsifiers are used to reduce viscosity and enable milling of solid particles in the oil (as a non-limiting example for liquid lipids), within the suspension which includes only an oil phase, without a liquid water phase. Accordingly, without being bound by theory, lecithin, monoglycerides, and other disclosed emulsifiers may be acting as viscosity reducing agents (and possibly also as emulsifiers once the suspensions are mixed with products having a water phase). In certain embodiments, emulsifier(s) may further be used to improve stability and homogeneity of the suspension, especially for second fine milling step 90B. The amount and/or type of the emulsifier(s) may be selected to functionally support the respective particle size reduction steps 90A and/or 90B.

Moreover, from the food engineering perspective, disclosed suspensions may be processed at high throughputs (e.g., 100 kg/hr or more), and from the logistics perspective, concentrated suspensions may reduce the shipped bulk, as they may be diluted after shipment.

In various embodiments, the micronized edible particles may have a median particle size between 1-15 μm (e.g., between 1-3 μm, between 3-5 μm, between 5-10 μm, between 10-15 μm or any intermediate value), a D10 diameter percentile between 0.4-5 μm (e.g., between 0.4-1 μm, between 1-2 μm, between 2-3 μm, between 3-4 μm, between 4-5 μm, or any intermediate value), and/or a D90 diameter percentile between 5-100 μm (e.g., between 5-20 μm, between 10-30 μm, between 30-50 μm, between 40-100 μm, or any intermediate value). Table 2 provides experimental results concerning the percentiles of the particle size distribution (PSD) following the first and second milling steps.

TABLE 2
Percentiles of the particle size distribution (PSD)
following the first and second milling steps.

| | D10 [μm] | D50 [μm] | D90 [μm] |
|---|---|---|---|
| First step 90A | 1-10 | 10-70 | 70-350 |
| Second step 90B | 0.4-5 | 1-15 | 5-100 |

It is noted that the provided ranges for particle size percentiles are non-limiting examples, and specific solids may be milled to yield different percentile values.

Referring to FIG. 1A, the illustrated two particle size reduction steps 90B, 90C may be applied to the raw tahini or other raw seed paste, which is prepared in the prior art by milling the respective seeds (e.g., sesame for tahini, or other seeds or nuts), e.g., in a stone mill or using rolls or a Macintyre (refiner-conche). In various embodiments, solid particles 70A may comprise sesame particles in the tahini, or seed particles in other seed pastes. While the present disclosure provides the particle size reduction steps 90B, 90C for refining prior art raw tahini, process 90 may also comprise an initial particle size reduction step 90A as applied in the prior art to yield raw seed paste (e.g., tahini). Referring to FIG. 1B, three-step particles size reduction process 90 may be implemented to prepare disclosed fine seed paste (e.g., tahini), according to some embodiments of the invention. While prior art raw tahini or other seed paste—typically includes particle diameters of 100 μm or more (and even fine prior art raw tahini includes particle diameters of 15 μm or more), disclosed embodiments yield much finer tahini, reaching particle diameters below 15 μm or below 10 μm, e.g., between 6-11 μm (for the D50 percentile).

In some embodiments, stages 90A, 90B, 90C may comprise different types of mills, each reducing about an order of magnitude in particle sizes. For example, starting with raw sesame, first stage 90A may reduce particle diameters, using shearing device 80, from the seeds to 150-1000 μm e.g., as used to prepared prior art raw tahini (or other types of seed paste). Following, stage 90B may include using shearing device 80 such as a high sheer homogenizer, or milling device 60 to further reduce particles sizes by an order of magnitude, e.g., to diameters around 15-150 μm, and third stage 90C may include using milling device 60 such as a ball mill to reduce particles' sizes by another order of magnitude to the final required size, e.g., to diameters around or under 15 μm or around or under 10 μm. Advantageously, using multiple milling stages and machine types allow optimizing the milling process to optimize the energetic efficiency and duration of the milling process, maintain a relatively continuous particle size distribution (PSD) and avoiding or minimizing oxidation of the product during milling. In some embodiments, first stage 90A may be configured to reduce particle diameters in milling device 60, e.g., having large milling media (e.g., between 0.5 mm and 2 mm).

It is noted that the term “raw tahini” is used herein to denote commercial tahini products that are typically used to prepare tahini spreads and other products by mixing the raw tahini with water, spices and additional ingredients. Raw tahini typically has large particles with D50>15 μm even for the finest commercial raw tahini and typically with D50 of tens of μm, commonly reaching around 70 μm. It is further noted that any of the disclosed seed pastes may be prepared from raw or processed seeds (e.g., roasted, possibly preceded by soaking, or any other form of processing).

Disclosed experiments show that due to an increased surface area of the finely-milled sesame particles in the disclosed tahini, a better water absorption is achieve in the disclosed fine tahini with respect to the raw tahini and also a better texture results for the disclosed fine tahini when mixed with water to yield a dip or a spread with water compared to the raw tahini.

Disclosed experiments show that such size reduction does not only make the tahini much finer and improves its texture, but also improvs the tahini taste (inducing richer taste and reducing bitterness) and the structural stability over time of the tahini paste. Moreover, mixtures of disclosed tahini to form other types of spreads (e.g., hummus) yield better tasting products and/or require using less tahini to yield the required taste and texture.

These results indicate that disclosed methods also apply to seed paste made of seeds and/or nuts other than sesame, as the seeds or nuts may likewise be processed as disclosed, to yield fine seed paste.

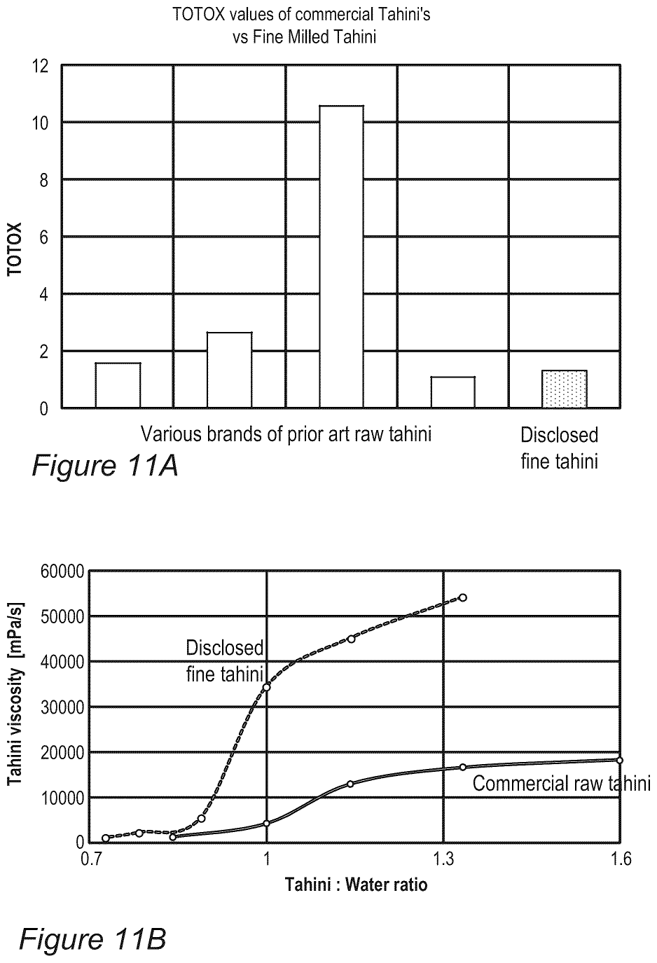

Various embodiments comprise a single pass milling 90C of the respective seeds, within a reasonable timeframe, and without or with a minimal and acceptable level of oxidation—avoiding long exposure of the milled paste to air and high temperatures. As indicated by experimental results (see, e.g., FIG. 11A), the additional milling does not degrade the nutritional values of the tahini—e.g., does not result in higher oxidation levels, and improves many organoleptic and other properties, as disclosed herein.

In some embodiments, raw tahini paste, e.g., commercial tahini, may be used as a starting point for further milling by stage 90C. Milling quality was optimized gradually, using multiple passes through the milling step—until the parameters for a single pass were achieved and optimized with respect to the type of machine and scale of operation. Particle size distribution (PSD) before and after milling was characterized using Malvern Mastersizer™, and viscosity tests were performed pre- and post-milling. Comprehensive tasting tests were conducted to evaluate the organoleptic effect of the milling process, including a comparative test between original (raw) and post-milling (fine) tahini and a final application test as tahini salad (mixed with water and salt).

Sensory evaluations were performed on the tahini paste and raw tahini before and after the milling process. Initial premixing (including slight heating and homogenization) was applied to yield a flowable mixture, having a similar PSD as the raw tahini paste (very large particles around 1 mm were removed in the homogenization preparation). Initially, raw tahini had high viscosity (ca. 900 cp) which required gradual experimental evaluation, and some preheating (to 70° C.) followed by cooling. Clearly, these parameters of the experimental setting are not limiting in implementing disclosed processes to commercial scales, and the required adaptations are expected to be straightforward.

Various embodiments comprise a single pass process that is optimized for commercial production, achieved by controlling the particle size distribution (PSD) at the entry to each particle size reduction step, the flow rate of the product, the rotation speed (RPM—rotations per minute) and the tip speeds of the corresponding milling rotor(s), the size and % volume of the milling media, the temperature of the milling chamber and other relevant commercial production parameters.

In various embodiments, disclosed fine tahini may have a D10 percentile of particle sizes under 8 μm, a D50 percentile of particle sizes under 15 μm, and/or a D90 percentile of particle sizes under 100 μm.

The whole production process may be optimized with respect to multiple performance parameters (e.g., time, resulting PSD, efficiency, temperature, energy consumed, relations between process steps etc.), for each type of seed. In the non-limiting example of tahini, and probably on comparable seeds, the production process may comprise three main steps: (i) Coarse milling of the seeds to a rough slurry 90A and optionally filtering out large particles (e.g., larger than 500 μm), (ii) fine milling of the rough slurry to form the seed paste with particle diameters between 15-60 μm 90B and (iii) finest milling of the seed paste to reach D50 percentile of particle diameters around or under 15 μm or around or under 10 μm 90C. It is noted that while step (ii) 90B may be extended to reduce particle sizes below 15 μm or below 10 μm, such extension is not practiced in the prior art because it requires much longer milling time, higher energy, higher temperatures (leading to unwanted oxidation) and results in slower production throughput. Instead, disclosed embodiments utilize the different milling machinery of step (iii) 90C to reduce particle sizes below 15p m or below 10 μm, saving multiple resources (time, energy, increasing throughput and avoiding oxidation). Moreover, in disclosed embodiments step (iii) 90C may be applied to larger initial particle sizes (e.g., diameters around 60 μm) to further reduce costs and disadvantages involved in step (ii) 90B, or even starting directly with raw commercial tahini—while reaching an improved final fine paste after step (iii) 90C. In the example of starting with raw commercial tahini (having e.g., particle diameters between 50-100 μm), disclosed embodiments may include either step (iii) 90C (e.g., milling) alone, or combine step (ii) 90B (e.g., pre-milling using a high shear homogenizer) for a short time (e.g., to reduce D50 to an intermediate value, e.g., 20 μm), followed by step (iii) 90C (e.g., milling) to further reduce the particle diameters in the paste from e.g., 20 μm down to e.g., 5 μm. It is noted that in the latter option (two-step process starting from raw commercial tahini), initial step (ii) 90B may be brief, homogenizing the raw commercial tahini and reducing particle size as a preparatory step for step (iii) 90C (e.g., milling).

Referring to FIG. 1A, two particle size reduction steps 90A, 90B may be implemented to prepare disclosed finely-ground coffee, according to some embodiments of the invention. While prior art coffee typically includes particle sizes of 50-100 μm or more, disclosed embodiments yield much finer ground coffee, achieved through implementation of second particle size reduction steps 90B as explained herein, and reaching particles sizes below 10 μm, e.g., between 5-7 μm (for the D50 percentile). Disclosed experiments show that such size reduction does not only make the coffee particles sizes much smaller, but also improves and enhances the taste of the coffee. For example, first particle size reduction step 90A may comprise a coarse shearing step involving size-reducing mechanical interactions between solid coffee particles 70A and a shearing device 80, e.g., comprising a rotor 80B rotating with respect to a stator 80A, with a shearing gap 80C in-between, into which an initial suspension of solid particles 70A in oil (as a non-limiting example for liquid lipids) is introduced and in which particle size is reduced to yield solid particles 70B. Second particle size reduction step 90B may comprise a fine milling step involving size-reducing mechanical interactions among solid coffee particles 70B (following initial particle size reduction step 90A) and/or between solid coffee particles 70B and a milling device 60, e.g., comprising a rotating shaft 60A, delivering rotation into a milling chamber 60B with milling media 60C, in which particles 70B collide and their sizes are reduced to yield disclosed suspensions with micronized particles 70C (illustrated in a highly schematic manner).

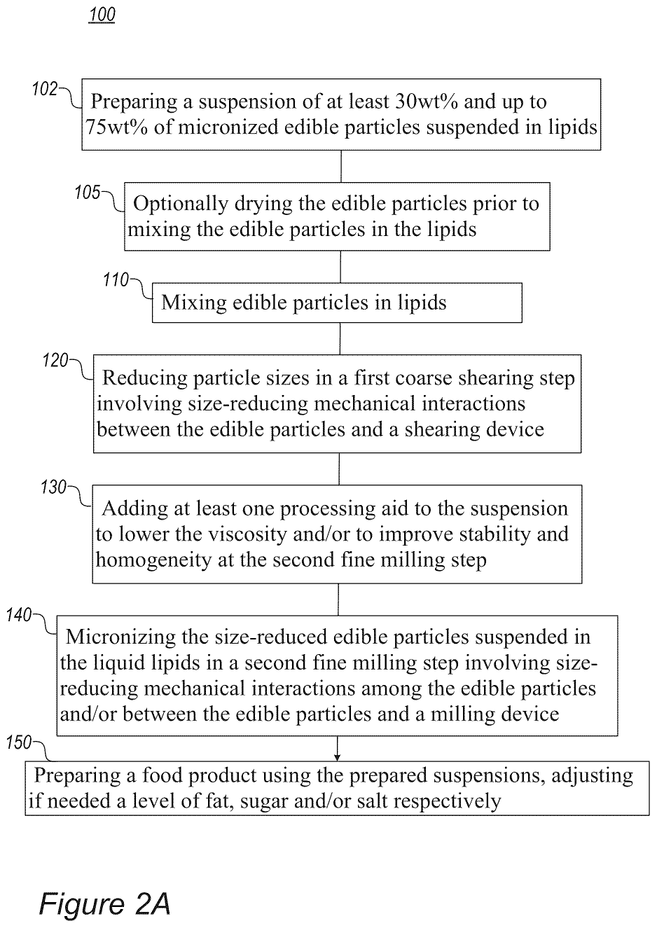

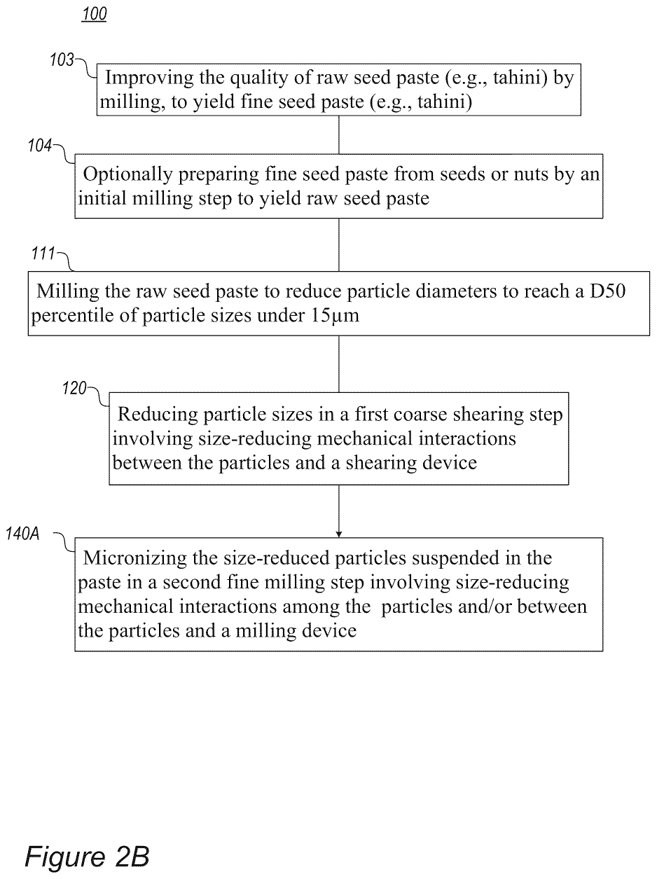

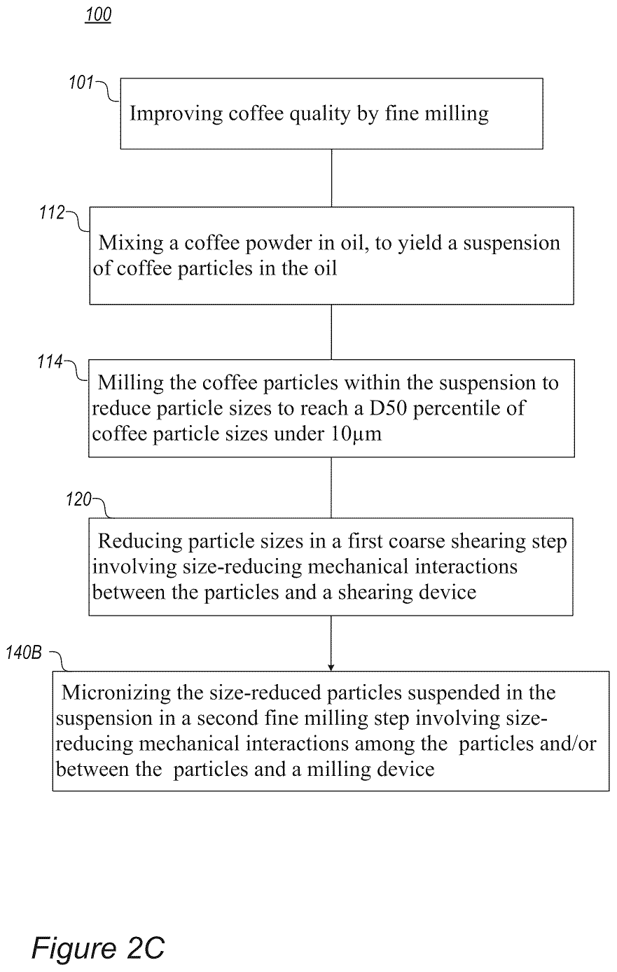

FIGS. 2A-2C are high-level flowcharts illustrating method variants of preparing suspension of at least 30 wt % micronized edible particles suspended in liquid lipids, optionally including coffee particles, as well as preparing and refining various seed pastes, according to some embodiments of the invention.

FIG. 2A is a high-level flowchart illustrating a method 100 of preparing a suspension of at least 30 wt % and up to 75 wt % micronized edible particles suspended in liquid lipids (stage 102), according to some embodiments of the invention. The method stages may be carried out with respect to particles size reduction process 90 described above, which may optionally be configured to implement method 100. Method 100 may comprise the following stages, irrespective of their order.

Method 100 comprises mixing edible particles in liquid lipids (stage 110), optionally drying the edible particles prior to mixing the edible particles in the liquid lipids (stage 105), e.g., in oil or liquefied fat. Method 100 further comprises reducing particle sizes in a first coarse shearing step involving size-reducing mechanical interactions between the edible particles and a shearing device (stage 120) and micronizing the size-reduced edible particles suspended in the oil in a second fine milling step involving size-reducing mechanical interactions among the edible particles and/or between the edible particles and a milling device (stage 140). Method 100 may further comprise adding at least one processing aid (e.g., emulsifier(s)) to the suspension to lower the viscosity and/or to improve stability and homogeneity at the second fine milling step (stage 130). The edible particles may comprise at least one of crystalline sugar, crystalline salt and spice particles, and the suspension may be used for preparing various food products, adjusting the respective fat and sugar/salt levels respectively. Accordingly, method 100 may further comprise preparing a food product using the prepared suspensions, adjusting if needed a level of fat, sugar and/or salt respectively (stage 150).

FIG. 2B is a high-level flowchart illustrating methods 100 of preparing fine seed paste from raw seed paste (improving the quality of the seed paste), according to some embodiments of the invention. The method stages may be carried out with respect to particles size reduction process 90 described above, which may optionally be configured to implement method 100. Method 100 may comprise the following stages, irrespective of their order. Tahini prepared from sesame seeds is provided as a non-limiting example for seed paste prepared from various kinds of seeds and/or nuts.

Method 100 may comprise improving the quality of raw seed paste (e.g., tahini) by milling to yield fine seed paste (e.g., tahini) (stage 103), by milling the raw seed paste to reduce particle sizes to reach a D50 percentile of particle diameters under 15 μm or under 10 μm (stage 111). Typically, in commercial settings, method 100 is optimized to require a single pass, by optimizing the production parameters.

Method 100 may optionally comprise preparing fine seed paste from corresponding seeds and/or nuts, e.g., by an initial milling step to yield raw seed paste (stage 104), e.g., tahini made of sesame seeds.

Method 100 may further comprise reducing particle sizes (e.g., of seed particles within the oily paste, such as sesame particles within the oily tahini paste) in a first coarse shearing step involving size-reducing mechanical interactions between the particles and a shearing device (stage 120) and micronizing the size-reduced particles suspended in the paste in a second fine milling step involving size-reducing mechanical interactions among the particles and/or between the particles and a milling device (stage 140A).

In some embodiments, preparing seed paste from corresponding seeds or nuts (e.g., fine tahini paste from sesame seeds) may include a first step of reducing particle diameters from the seeds to between 150-1000 μm (e.g., to yield raw seed/tahini paste). From the raw seed/tahini paste, method 100 may comprise preparing fine seed/tahini paste by a step of reducing particle diameters to between 15-150 μm (e.g., by shearing in a shearing device, by milling with a mill or rolls, etc.), and a step of further reducing particle diameters to around or under 15 μm or around or under 10 μm (e.g., by milling in a shearing device).

It is noted that when preparing fine seed/tahini paste from seeds (e.g., sesame or other seeds or nuts), three steps may be used: a first step of reducing particle diameters from the seeds to between 150-1000 μm, a second shearing step of reducing particle diameters to between 15-150 μm and a third milling step of reducing particle diameters to around or under 15 μm or around or under 10 μm, each step carried out through a different machine. When preparing fine seed/tahini paste from raw seed/tahini paste, two steps may be used: a first shearing step of reducing particle diameters to between 15-150 μm and a second milling step of reducing particle diameters to around or under 15 μm or around or under 10 μm, each step carried out through a different machine.

In some embodiments, the disclosed fine tahini paste may be made directly of sesame seeds by at least four milling steps comprising: a first step of reducing particle diameters from the seeds to between 150-1000 μm, a second step of reducing particle diameters from the first step to between 30-200 μm, and a third step of reducing particle diameters from the second step to around or under 20-30 μm. A fourth step reducing the particle diameters from the third step to around 1-10 μm, e.g., between 2-5 μm.

FIG. 2C is a high-level flowchart illustrating methods 100 of preparing finely-ground coffee to improve coffee quality (stage 101), according to some embodiments of the invention. Method 100 may comprise the following stages, irrespective of their order.

Method 100 comprises mixing a coffee powder in oil, to yield a suspension of coffee particles in the oil (stage 112), and milling the coffee particles within the suspension to reduce particle sizes to reach a D50 percentile of coffee particle sizes under 10 μm (stage 114).

Method 100 may further comprise reducing particle sizes (e.g., of coffee particles within the oil) in a first coarse shearing step involving size-reducing mechanical interactions between the particles and a shearing device (stage 120) and micronizing the size-reduced particles suspended in the suspension in a second fine milling step involving size-reducing mechanical interactions among the particles and/or between the particles and a milling device (stage 140B)—e.g., corresponding to size reduction steps 90A, 90B described in FIG. 1A.

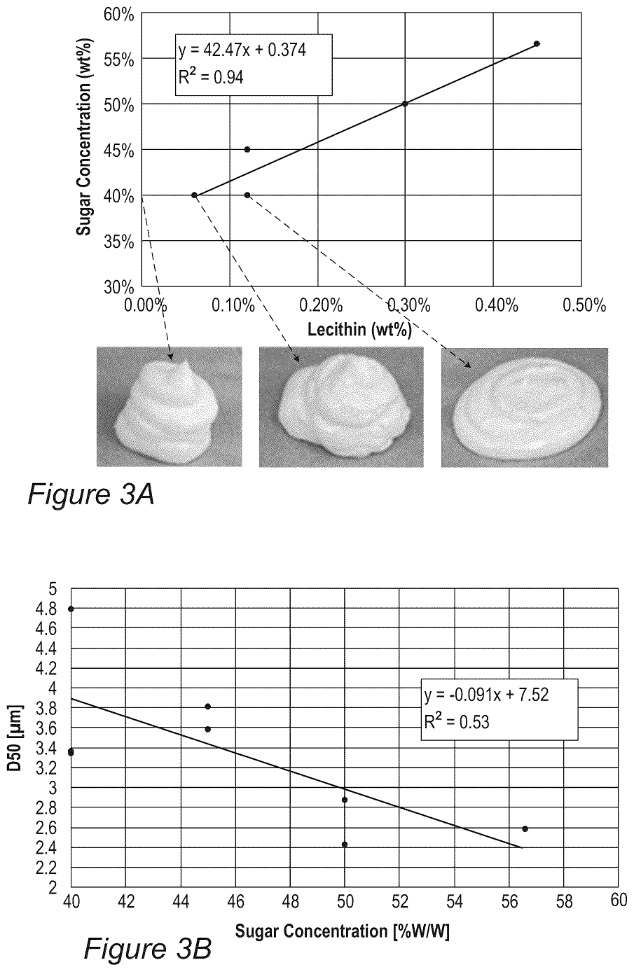

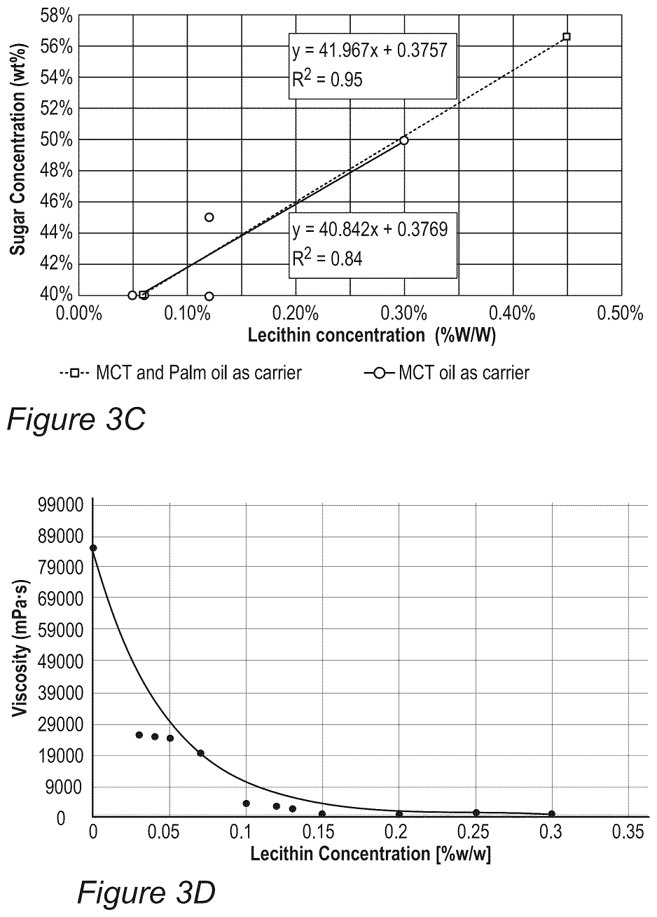

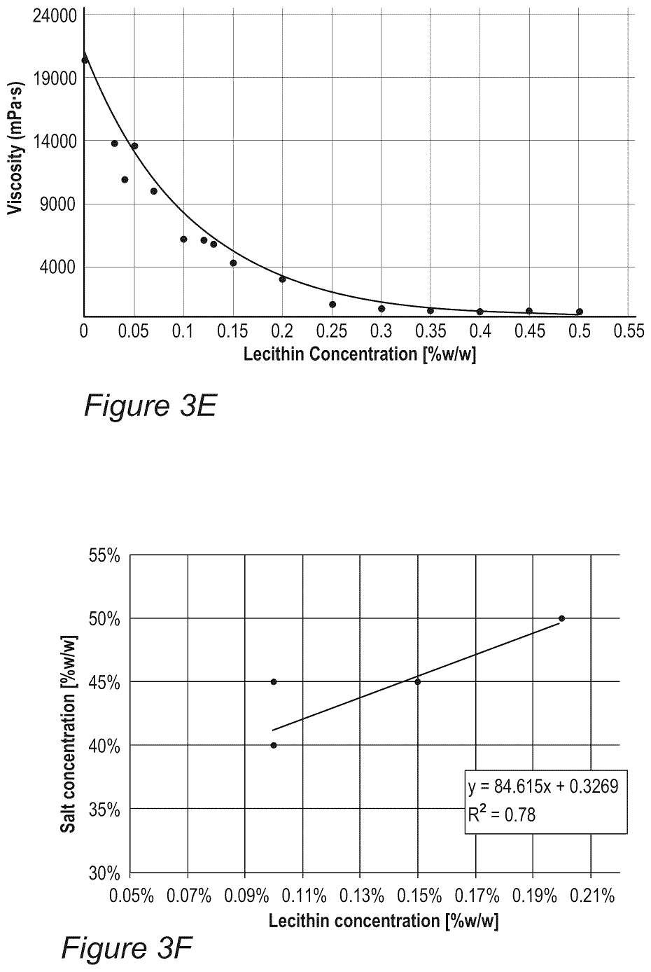

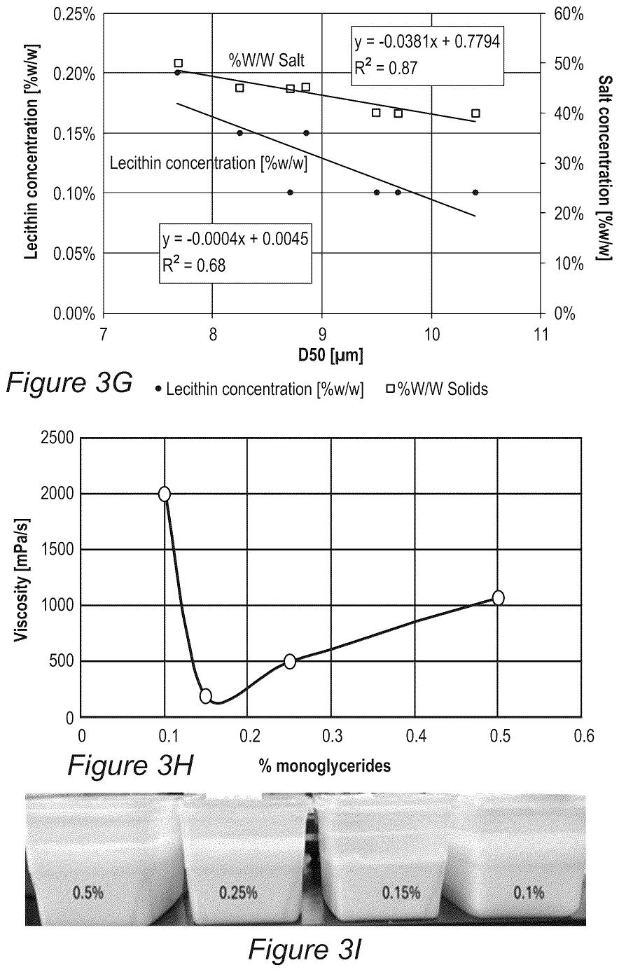

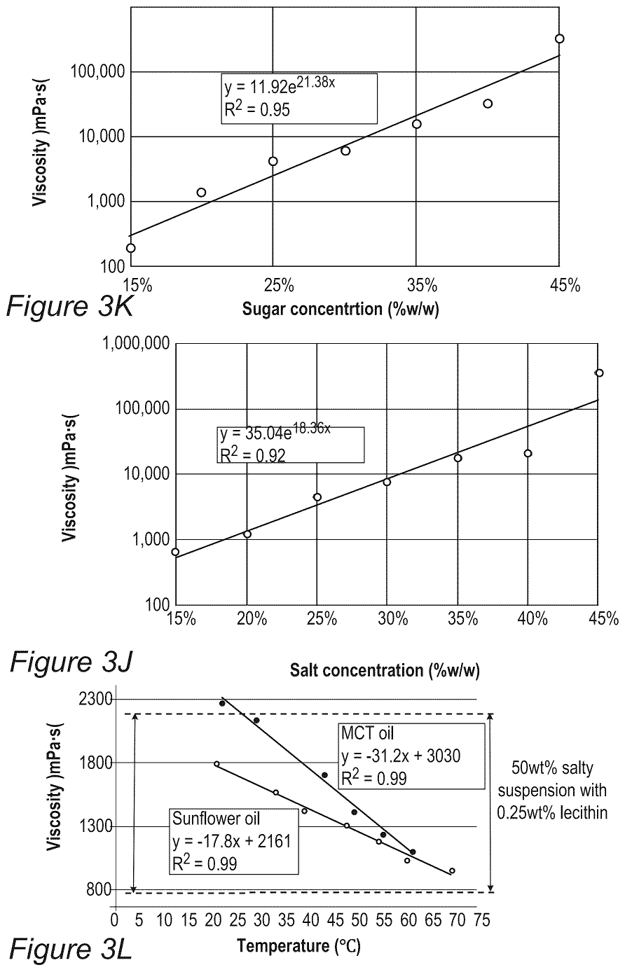

FIGS. 3A-3I provide experimental results concerning disclosed suspensions and their production methods 100, according to some embodiments of the invention. In the experiments, sugar in oil suspensions with 40 wt %, 45 wt %, 50 wt %, 55 wt % and 57 wt %, and salt (NaCl) in oil suspensions with 40 wt %, 45 wt % and 50 wt % were produced, with sugar and salt as a non-limiting examples for edible solids. Oils, mostly MCT oils, were used as a non-limiting example for lipids. Lecithin as a non-limiting example of a processing aid was added to the sugar or salt in oil mixture (prior to both size reduction steps 90A, 90B) at concentrations of 0.03 wt %, 0.06 wt %, 0.16 wt %, 0.12 wt %, 0.15 wt %, 0.18 wt %, 0.2 wt %, 0.24 wt %, 0.3 wt %, 0.42 wt %. Second particle size reduction step 90B was operated at constant conditions (pump flow 320 ml/min and rotation at 3400 RPM) for measuring the influence of adding lecithin at different concentrations. In various embodiments, lecithin may be added before any of the size reductions stages, e.g., to the initial suspension (before step 90A), to the intermediate suspensions (before step 90B), or to intermediate suspensions in a multi-stage process (before final step 90C in FIG. 1B), Table 3 provides experimental results concerning the percentiles of the particle size distribution (PSD) for the various suspension compositions. It is noted that these results are non-limiting in the sense that modifications of the composition and milling parameters may yield broader ranges for the PSD, e.g., D10 between 0.4-5 μm, median (D50) between 1-15 μm and D90 between 5-100 μm, or within subranges thereof.

TABLE 3
Percentiles of the particle size distribution
(PSD) for the various suspension compositions.

| Solids wt % | Lecithin wt % | D10 (μm) | D50 (μm) | D90 (μm) |
|---|---|---|---|---|
| Sugar - 40 | 0.00 | 1.5 | 5.9 | 11.9 |
| Sugar - 40 | 0.03 | 0.7 | 3.4 | 10.8 |
| Sugar - 40 | 0.06 | 0.9 | 4.8 | 10.8 |
| Sugar - 40 | 0.12 | 0.8 | 3.3 | 12.4 |
| Sugar - 45 | 0.12 | 1.0 | 3.8 | 14.8 |
| Sugar - 45 | 0.18 | 0.9 | 3.6 | 14.9 |
| Sugar - 50 | 0.24 | 0.9 | 2.9 | 6.7 |
| Sugar - 50 | 0.30 | 0.9 | 2.4 | 7.1 |
| Sugar - 57 | 0.42 | 0.7 | 2.6 | 10.6 |
| Salt - 40 | 0.10 | 4.8 | 9.5 | 19.2 |
| Salt - 40 | 0.10 | 5.4 | 10.4 | 19.4 |
| Salt - 40 | 0.10 | 4.8 | 9.7 | 18.3 |
| Salt - 45 | 0.10 | 4.4 | 8.7 | 16.6 |
| Salt - 45 | 0.15 | 4.3 | 8.9 | 17.9 |
| Salt - 45 | 0.15 | 4.4 | 8.3 | 15.1 |
| Salt - 50 | 0.20 | 2.7 | 7.7 | 16 |

Additional experiments were carried out with 40 wt % sugar and 0.05 wt % lecithin in MCT oil compared with 56.6 wt % sugar and 0.45 wt % lecithin in palm oil.

It is noted that sugar and salt (NaCl) differ in their hardness (7 and 2.5 on the Mohs scale, respectively) and in their specific gravity of 1.59 g/cm and 2.17 g/cm respectively)—affecting their relative rate of milling and of sedimentation. Milling parameters may be adjusted respectively.

FIGS. 3A-3L provide experimental results concerning the disclosed sugar and salt suspensions, according to some embodiments of the invention.

FIG. 3A provides results for sugar in oil suspensions with added lecithin, indicating that adding more lecithin as the sugar level is raised—enables to maintain operable milling processes 90A, 90B and liquid suspension. High solids concentrations may require adjustments of the milling parameters (e.g., reduction of the milling speed at second stage 90B). It was further noted that increasing concentrations of lecithin (e.g., from 0.00, thorough 0.06 wt % to 0.12 wt %, with 40 wt % sugar) reduced the viscosity of the suspension, from firm to soft, as illustrated in the inset images for 40 wt % sugar and 0.00, 0.06 wt %, 0.12 wt % lecithin. In some embodiments, lecithin concentrations may range between 0.00-0.25 wt % and sugar concentrations may range between 30-75 wt %.

FIG. 3B provides results for the median particle size of sugar in oil suspensions—indicating decreasing particle sizes for increasing sugar concentrations (see also Table 3)—providing a synergic effect of increasing sugar concentration, as smaller particles have enhanced taste in addition to the increased amount of sugar. Hence, high concentration suspensions may be especially useful for dilution before application. It is noted that lecithin contributes to this synergic effect, e.g., by supporting and enhancing particle size reduction. It is further noted that addition of lecithin also enables reduction of temperature and milling parameters like load on the milling machines.

FIG. 3C is similar to FIG. 3A, with an additional sugar in palm oil suspension with high sugar concentration. In certain embodiments, the oil used as carrier in the suspensions may comprise a mixture of different types of oils, e.g., MCT oil and palm oil, or any combinations of disclosed oils (e.g., cocoa butter, MCT oil, Ghee butter, palm oil, high olein palm oil, hazelnut paste, milk butter, refined coconut oil, sunflower oil, canola oil, soy oil, etc.—in liquid form) or animal fats like tallow, lard, duck fat, chicken fat etc. in their molten liquid form and/or any other form of liquid lipids.

FIG. 3D provides results for 40 wt % sugar in oil suspensions with added lecithin, indicating that a small amount of lecithin (e.g., up to 0.1 wt %) reduces the viscosity very significantly, followed by further, more gradual decrease in viscosity with increasing amounts of lecithin. The reduced viscosity enables to maintain operable milling processes 90A, 90B and the liquid suspension and enables milling the salt crystals to ever smaller sizes.

FIG. 3E provides results for 40 wt % salt (NaCl) in oil suspensions with added lecithin, indicating that a small amount of lecithin (e.g., up to 0.2 wt %) reduces the viscosity very significantly, followed by further, more gradual decrease in viscosity with increasing amounts of lecithin. The reduced viscosity enables to maintain operable milling processes 90A, 90B and the liquid suspension and enables milling the salt crystals to ever smaller sizes.

FIGS. 3D and 3E illustrate the decreasing viscosity of sweet and salty suspensions, respectively—as lecithin is added in increasing amounts. In both cases it seems that the degree of viscosity levels at under 1000 mPa s.

It was further moted that lecithin does not change the viscosity of MCT oil by itself, indicating lecithin's effect as a processing aid to reduce friction between the particles and the oil. The beneficial effects of lecithin are surprising, as there are no noticeable amounts of liquid water in the suspension, and hence, without being bound to theory, the function of the emulsifiers may be similar to their function in chocolate (which also does not contain added water).

It is noted that the process equipment 90B (e.g., ball mills for the second milling step) typically operate at relatively low viscosities (e.g., tens to hundreds of cP, e.g., up to 500 cP, optimally at a few tens of cP, e.g., due to required rheology of the material in order to undergo the milling processes, and lecithin or other processing aids (e.g., emulsifiers) shown here to reduce viscosity may enable processing suspensions with high solids content.

FIG. 3F provides results for salt in oil suspensions with added lecithin, indicating that adding more lecithin as the salt level is raised—enables to maintain operable milling processes 90A, 90B and liquid suspension. FIG. 3F for salt corresponds to FIG. 3A for sugar, indicating the broad range of edible solid particles that can be processed in disclosed methods. High solids concentrations may require adjustments of the milling parameters (e.g., reduction of the milling speed at second stage 90B).

FIG. 3G provides comparative results for salt in oil suspensions with added lecithin, indicating the decreases in resulting particle size (in terms of the median diameter D50) with increasing salt concentration and with increasing lecithin concentration. It is noted that the amount of solids and the amount of lecithin differ in the details of their effects on the particles sizes, and on the milling parameters (not shown), yet indicate the feasibility and efficiency of reaching oil suspensions with high solids content of micronized particles.

FIGS. 3H and 3I provide experimental results concerning using monoglycerides to reach high salt concentrations in the disclosed salt suspensions, according to some embodiments of the invention. Similar products may be prepared with monoglycerides and high concentrations of sugar or other disclosed particles in the disclosed suspensions and pastes. Monoglycerides may be used in addition to or in place of lecithin to lower the product viscosity, stabilize the suspension and/or increase the shelf life of the products. In the illustrated non-limiting example, branded monoglycerides were used, which were prepared from fully hydrogenated vegetable oil and include at least 95% monoesters (typically 1-monoglycerides of palm oil including glycerol linked to one fatty acid via an ester bond, usually saturated fatty acids such as palmitic or stearic acids).

In the non-limiting experimental setting, suspensions of table salt in MCT oil with variable amounts of monoglycerides were compared. 1 kg of MCT was placed in the thermomixer and warmed to 50° C. under low mixing intensity. 3-10 gr of monoglycerides were weighed into 15 mL tubes each, and MCT oil was added to fill the tubes. The tubes were placed in a water bath at 90° C. to melt and dissolve the monoglycerides. Once the monoglycerides were dissolved, the solution was poured into oil. After adding the monoglycerides, 1 kg of table salt was added, and the spinning power was increased to 8, for 12 minutes total of milling. The viscosity of the samples was measured at 45-50° C. as well as at RT (room temperature). The premix samples were 50% salt in MCT oil, with different amounts of 0.5%, 0.25%, 0.15% and 0.1% added monoglycerides. In some embodiments, polyglycerol polyricinoleate (PGPR) was shown to provide comparable benefits. Table 4 provides the PSD results of the premixes with different monoglycerides concentrations after homogenizing using the kitchen blender. The volume size population of the different premixes were similar, with some differences, mainly smaller particles more prevalent at lower concentration of monoglycerides.

TABLE 4
PSD results of the premixes with varies
mono concentrations (in μm).

| | |
|---|---|
| % mono- | Percentile of the distribution |

| glycerides | 10 | 50 | 90 | 95 | 100 |
|---|---|---|---|---|---|
| 0.5 | 9.14 | 39.0 | 207 | 270 | 747 |
| 0.25 | 8.30 | 34.3 | 189 | 234 | 398 |
| 0.15 | 5.59 | 35.9 | 191 | 237 | 399 |
| 0.1 | 8.12 | 32.2 | 188 | 231 | 396 |

In a non-limiting examples, it is possible to achieve a sugar suspension of D50=5 μm by combinations of the following chamber filling volume fractions: (i) Media (milling balls)—85% of the chamber volume, oil—7.5% of the chamber volume, and sugar—7.5% of the chamber volume (the product then contains 50% sugar and 50% oil); (ii) Media— 80% of the volume, oil—7.5% of the volume, and sugar—12.5% of the volume (the product then contains 60% sugar and 40% oil); (iii) Media— 75 vol %, oil 7.5 vol %, and sugar 17.5 vol % (the product then contains 70% sugar). By increasing the fraction of edible solids in the milling process two benefits are achieved: (i) The final product contains more solids, is more concentrated and is more beneficial for the user, and (ii) the throughput in kg/hr is higher and more profitable in terms of machine time and energy efficiency. The volume % of media may be further reduced under various configurations, to further increase the efficiency and throughout of the process.

FIGS. 3J-3L provide additional experimental results concerning the disclosed sugar and salt suspensions, according to some embodiments of the invention. FIGS. 3J and 3K depict the increasing viscosity of sugar and salt suspensions. FIG. 3L illustrates the effects of temperature on viscosity, for 50% salty suspensions with 0.25% lecithin, and two different types of carrier oil (MCT oil and sunflower oil. The composition of specific solutions (type and amount of edible solids, type of oil, and concentration of lecithin) may be adjusted to their respective use and required viscosity, as well as with respect to additional parameters and specifications concerning the end product and/or the production process.

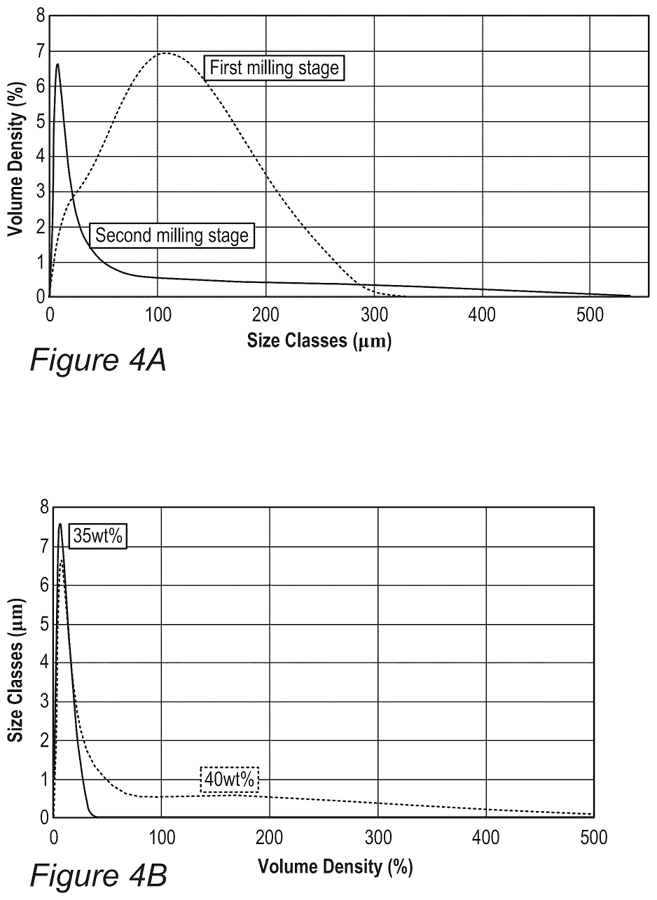

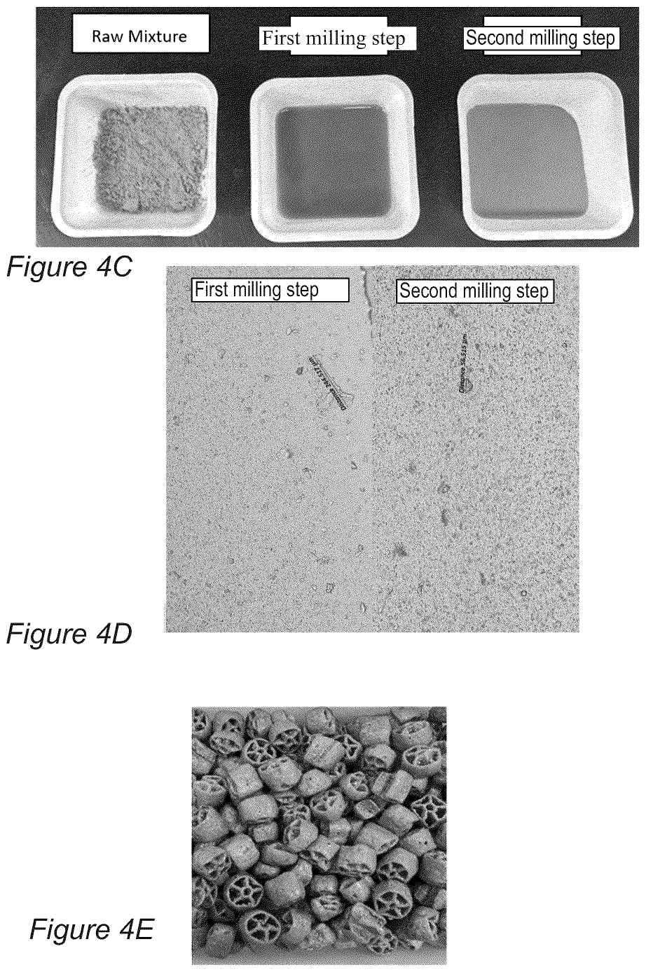

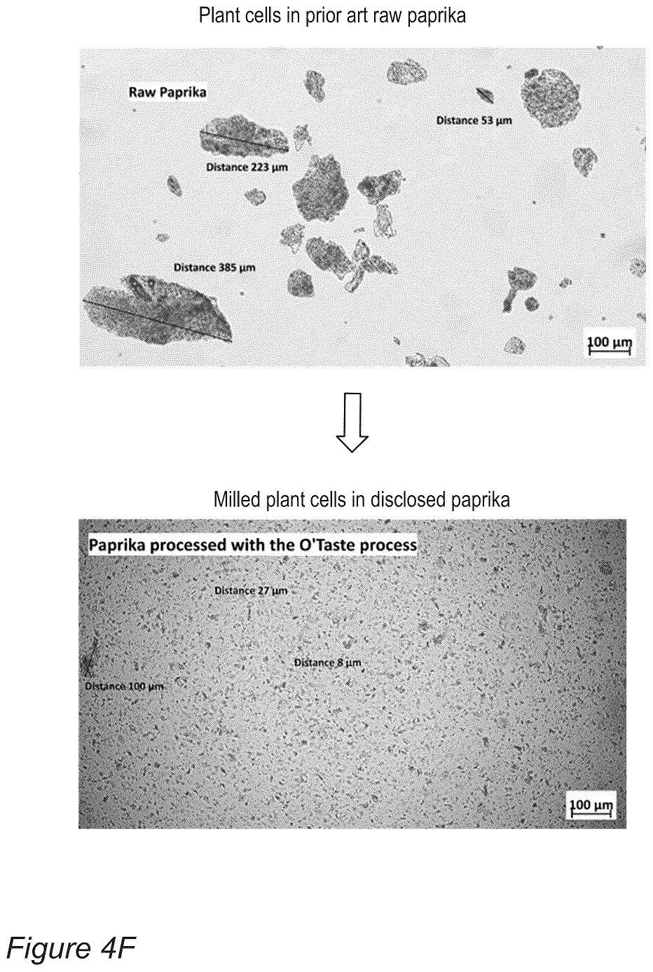

FIGS. 4A-4F, 5A-5K and 6A-6D provide experimental results concerning the disclosed spicy suspensions, according to some embodiments of the invention. The disclosed spicy suspensions include mixtures of sugar, salt, MSG (monosodium glutamate) and spices as edible solids and flavorings, in different amounts and combinations that correspond to specific food product recipes and requirements.

FIG. 4A provides the particle size distributions after the first and second milling steps, indicating small particle size, mostly below 15 μm after the second milling step— for a 35 wt % solids suspension. FIG. 4B provides the particle size distributions after the milling step, indicating small particle size, mostly below 15 μm—for a 35 wt % solids suspension and for a 40 wt % solids suspension. The spice mixture was dried before preparation of the premix for milling. The concentrations of solids (sugar, salt and spices) in the disclosed spicy suspensions were 35 wt % solids mixed in 65 wt % MCT oil, and 40 wt % solids mixed in 60 wt % MCT oil, in different experiments. Due to the sensitivity of spices to heat, the milling steps were carried out under milder conditions than for milling sugar or salt alone. The particle size distribution achieved in multiple samples was characterized by D10 between 1.5-1.6 μm, D50 (median) between 6.1-7.7 μm, and D90 between 16-35 μm— for 40 wt % and 35 wt % suspensions, respectively.

FIGS. 4C-4E provide images showing the raw spices mixture, the premix suspension (following the first milling step) and the prepared suspension (following the second milling step, 35 wt % solids)—in FIG. 4C; microscopic images showing the size of the particles and the spaces between them after the first and after the second milling steps—indicating the significant reduction in particle size and homogenization of the suspension after the second milling step (35 wt % solids, ×10 magnification)—in FIG. 4D; and FIG. 4E provides an image of the final food product, an extruded and fried crunchy savory paste-based snack, coated by the suspension to reach a fine and glossy coating by the spicy suspension, that is homogenous and does not have rough particles as in prior art products. Coating was varied out in a single step, spraying the disclosed spicy suspension on the food products in the tumbler. The disclosed spicy suspensions were diluted with additional oil according to specifications by the producer (e.g., from 35 wt % to 19.4% in one case, and from 40 wt % to 32 wt % in another case—diluting the prepared suspension after the milling steps). A tasting panel evaluated food products prepared from disclosed spicy suspensions as having more intense flavor (e.g., slatier) compared to corresponding commercial products—suggesting the possibility of reducing amounts of salt, sugar and/or spices to achieve similar organoleptic properties, resulting in nutritional benefits of the disclosed suspensions.

FIG. 4F demonstrates in a visual manner the breaking of plant cells by disclosed milling processes, according to some embodiments of the invention. As illustrated, while commercial paprika spices include plant cells that enclose their content of nutritional, taste and color compounds, the plant cells are disrupted in the disclosed milling processes and disclosed finely milled paprika has enhanced nutritional values, more enhanced taste and color due to the released compounds from the cells' internal volumes. For example, prior to milling spice particles had typical sizes ranging between 50 μm and 400 μm, while after milling all cell structures are destroyed and their contents is freely available for digestions and to provide enhanced taste and color.

It is noted that the sizes of spice particles in typical spice mixtures have similar sizes to crystalline sugar particles in prior art sugar, e.g., with sizes measuring roughly 100 μm×50 μm. While crystalline particles like sugar and salt are broken down within the oil to form particles that are about an order of magnitude smaller, the inventors have found out that spice particles that in the prior art include plant tissue parts, even though being ductile, are completely milled in oil using disclosed method, breaking down all cell walls, which was unexpected in view of the rigid collisions model presented herein. Hence, not only suspensions of crystalline particles can be reduced in size using disclosed, method, but also soft plant tissue parts and plant cells may be disrupted to free internal compounds.

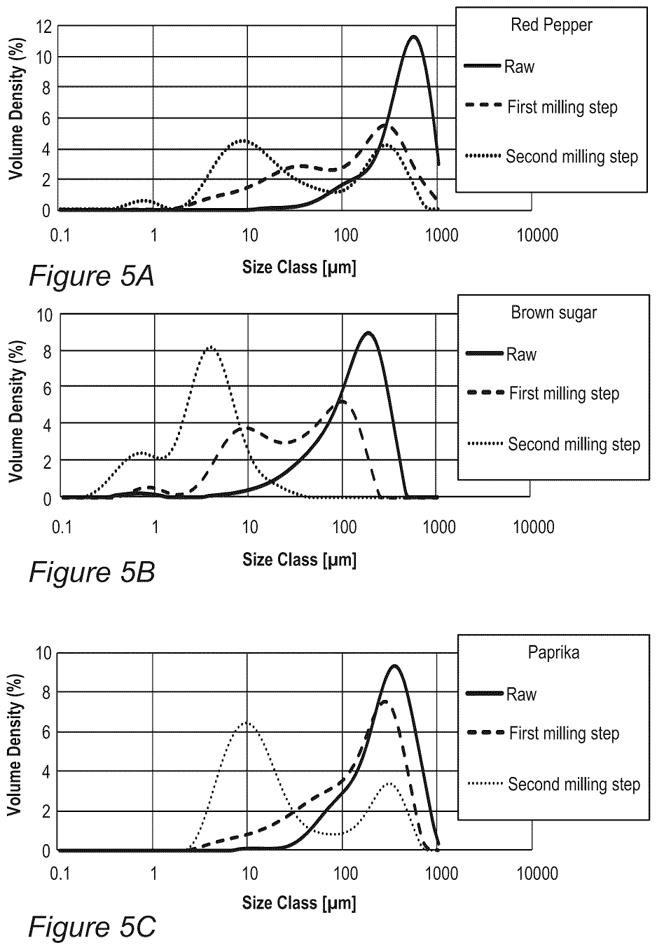

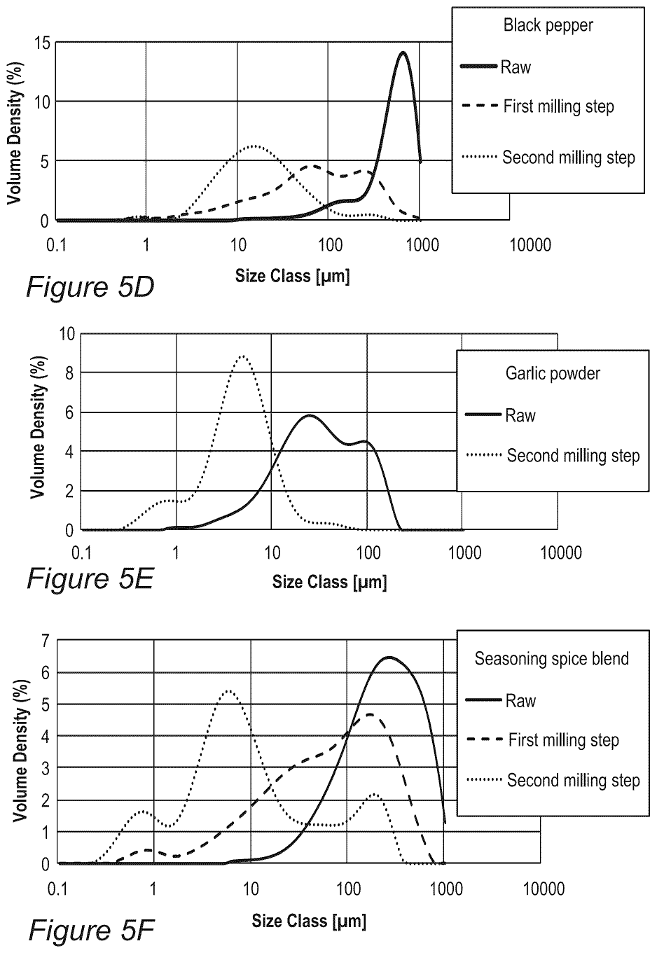

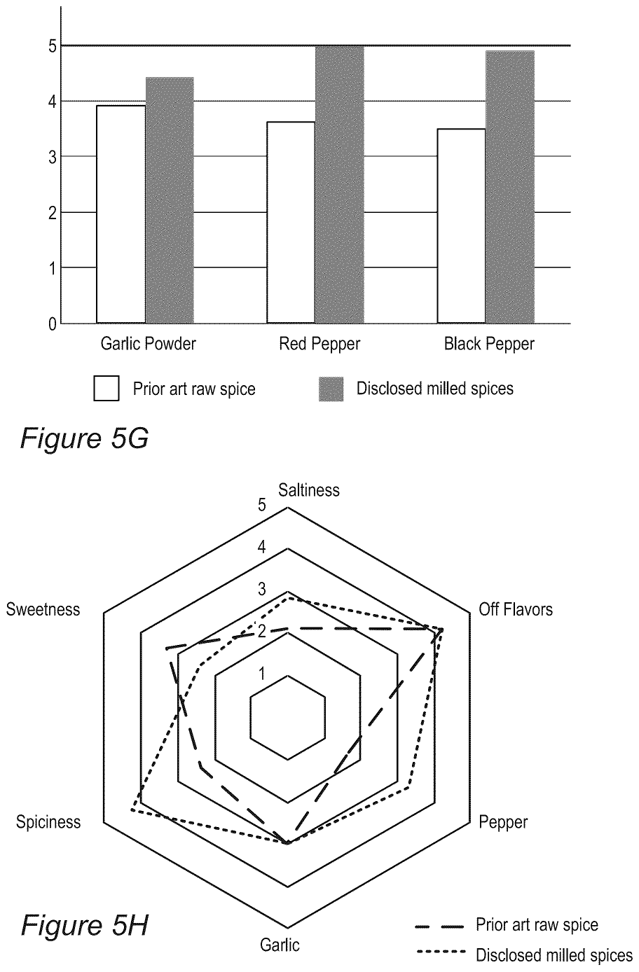

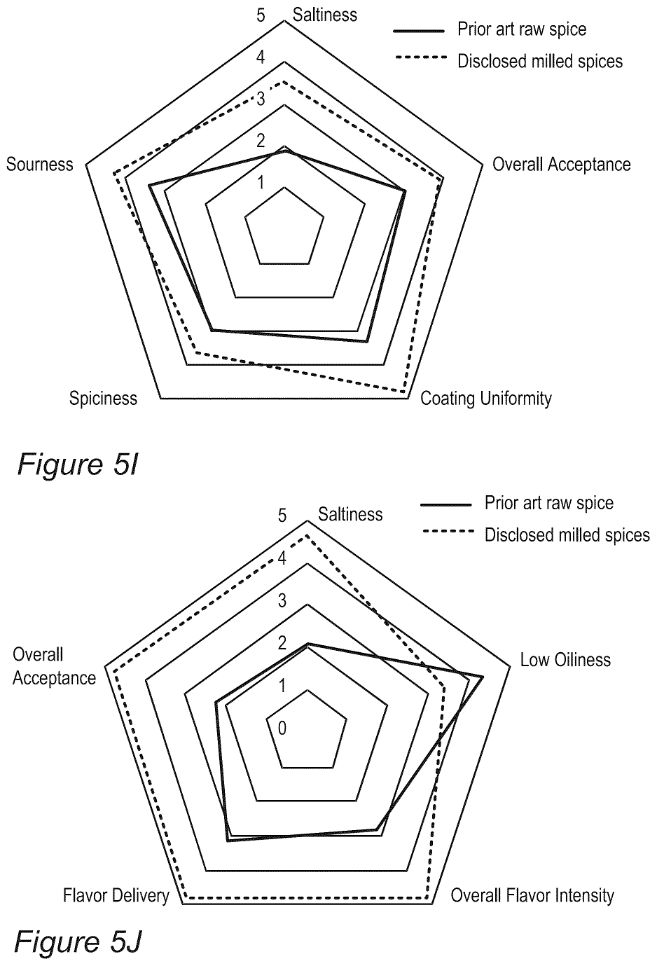

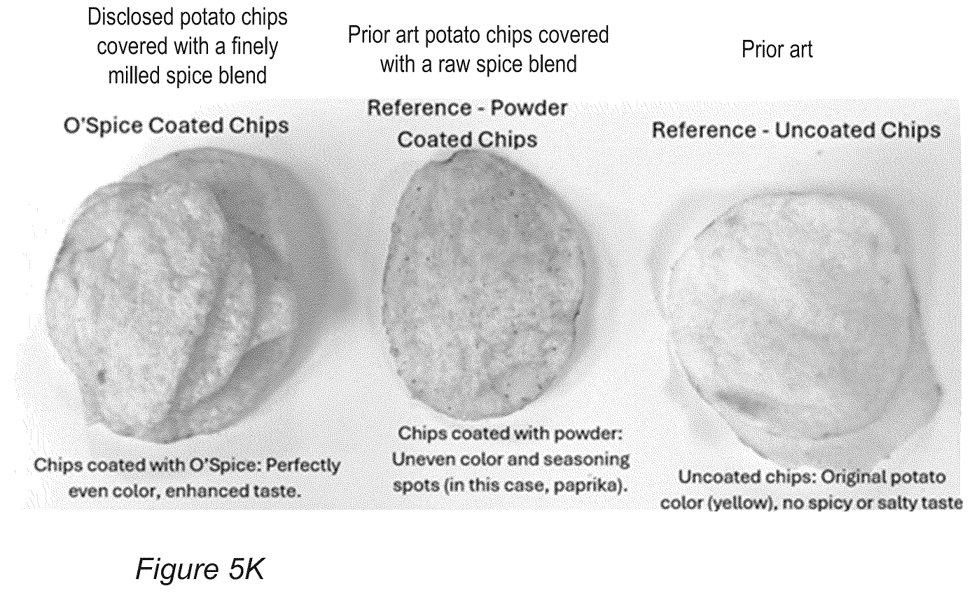

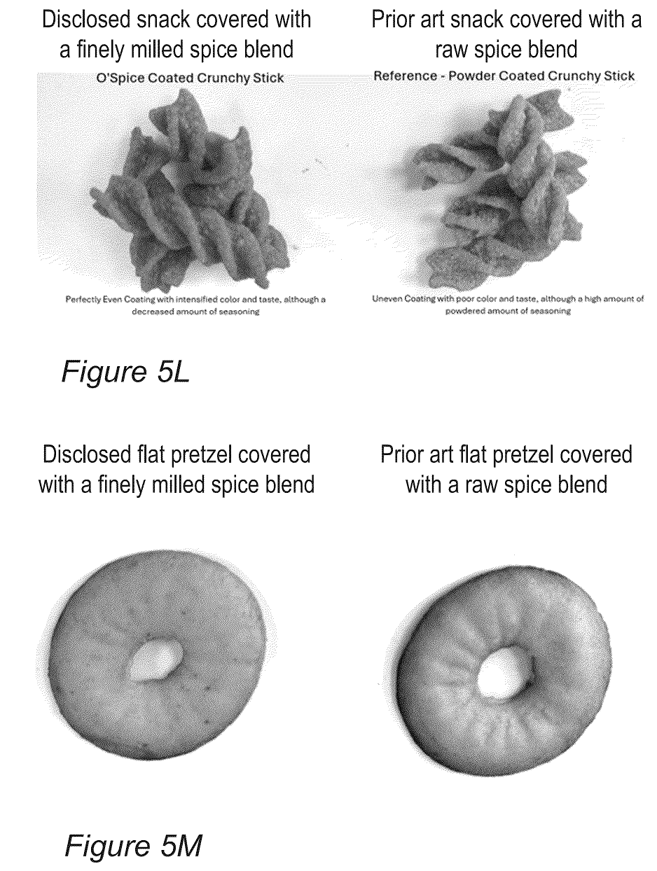

FIGS. 5A-5F provide particle size distributions for spices made of red chili peppers, brown sugar, paprika, black pepper, ground garlic and a seasoning blend, respectively, in prior art raw state, and after a first and a second milling stage as disclosed herein, according to some embodiments of the invention. The data for all six spices clearly show that the particle sizes decrease (the respective graphs shift to the left) and that their distribution becomes narrower at the final milling step— to yield much finer spice particles (suspended in oil), reducing the mode (most common value) by one to two orders of magnitude and reducing the media particle size by one or more orders of magnitude. In some of the cases, the milling also yielded a bi-modal distribution (see FIGS. 5A, 5C and 5F), a feature of the distribution which may also be controlled by setting parameters of the mills correspondingly. It is noted that all milled spices in oil provide enhanced taste and color.

FIGS. 5G-5K provide taste evaluations for the finely ground spices, according to some embodiments of the invention. FIG. 5G provides a comparison of the flavor intensity of disclosed finely milled spices according to some embodiments of the invention, compared with prior art spices. The taste evaluation was carried out by a professional tasting panel that evaluated the flavor intensity of each spice before and after disclosed milling process. All taste tests were conducted blindly. The panelists were asked to rate the flavor intensity on a scale of 1 to 5, 5 corresponding to the strongest flavor. The results shown are for seven panel participants, indicating that that when tasting each of the disclosed spices individually in comparison to the respective prior art raw spice—an increase in flavor intensity was observed?

FIG. 5H provides a tasting evaluation of disclosed finely milled blend of spices according to some embodiments of the invention, compared with prior art spice blends. The final spice blend was prepared using a specific formula, with salt and soybean oil, and evaluated by a panel of six professional tasters (blindly). As shown in FIG. 5G, spiciness and pepper (flavor intensity) were the most noticeable attribute to be increased by the disclosed fine milling, with saltiness also being heightened by the Sweetness appeared to decrease in the milled sample, which may be explained by the disclosed fine milling. It is noted that the significant increase in spiciness, pepper and saltiness tastes overshadow the small reduction in sweetness. No changes in off-flavors were detected. The overall scores (sum of partial scores) were 20.2 for the disclosed finely-milled spice, compared to 16.7 for prior art raw spice.

FIG. 5I provides a tasting evaluation of disclosed potato chips seasoned with a sour and sweet finely milled blend of spices according to some embodiments of the invention, compared with prior art potato chips covered by corresponding prior art raw spice blends. The evaluation was carried out by a panel of six professional tasters (blindly). The chart compares the flavor attributes of sour and spicy potato chips for disclosed potato chips compared with prior art potato chips. The chart includes five parameters: saltiness, overall acceptance, coating uniformity, spiciness, and sourness, each rated on a scale of 0-5. The control prior art snacks included 1200 mg sodium per 100 grams of chips and achieved an overall score of 14.8), while the disclosed potato chips had better results in all parameters, indicating enhanced tastes (saltiness, sourness and spiciness) while using half the sodium content (600 mg sodium per 100 grams of chips), a better coating uniformity and higher overall acceptance, with an overall score of 19.8.

FIG. 5K provides a comparison of potato chips, fried with disclosed one step method using seasoned oil, according to some embodiments of the invention, with chips fried according to the prior art two step method. FIG. 5K illustrates uncoated potato chips compared with prior art potato chips that are covered and fried with a prior art raw spice blend, and disclosed potato chips that are covered and fried with the disclosed finely-milled spice blend suspended on oil (see also FIGS. 5F-5J). The latter, disclosed potato chips are characterized by stronger taste provided by a smaller amount of spices and of salt. Disclosed potato chips also have a more uniform color and a smoother taste, as indicated in FIG. 5H-5J for various spicing variants.

FIG. 5J provides a tasting evaluation of disclosed crunchy sticks seasoned with a grill finely milled blend of spices according to some embodiments of the invention, compared with prior art crunchy sticks covered by corresponding prior art raw spice blends. FIG. 5J compares the sensory attributes of a grill-flavored wheat snack (industrial reference) with disclosed snacks that were prepared with disclosed finely-milled blend of spices, both containing 540 mg sodium per 100 grams. The chart evaluates five parameters (evaluated blindly by a panel of six professional tasters): saltiness, low oiliness, overall flavor intensity, flavor delivery, and overall acceptance, each rated on a scale of 1 to 5. Disclosed snacks score higher across all parameters (total score of 22.5 compared with prior art total scope of 14.7), particularly in overall flavor intensity and acceptance.

FIG. 5L provides a comparison of crunchy sticks, fried with disclosed one step method using seasoned oil, according to some embodiments of the invention, with crunchy sticks fried according to the prior art two step method. This image too demonstrates the color impact of the disclosed milling process. The images illustrate the differences in color between the final products, highlighting the enhancement of color intensity and uniformity achieved by disclosed milling and frying processes.

In another example, FIG. 5M provides a comparison of flat pretzels, fried with disclosed one step method using seasoned oil, according to some embodiments of the invention, with flat pretzels fried according to the prior art two step method. Flat pretzels prepared by disclosed methods have a more even coating and a more intensive and uniform color, while using a reduced amount of seasoning—compared with the prior art flat pretzel.

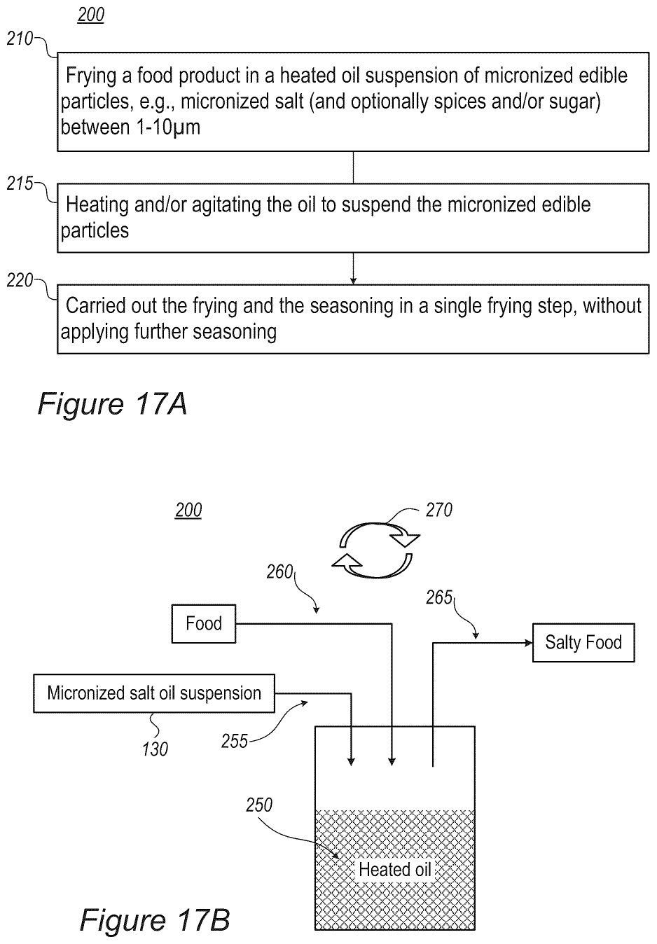

The final product pictures, as shown in non-limiting examples in FIGS. 4E and 5K-5M, demonstrate the color impact of the disclosed milling process. The images illustrate the differences in color among the final products, highlighting the ways in which the disclosed milling process enhances the color intensity and overall quality of the products. For example, FIG. 5K shows three potato chips placed side by side, each displaying a distinct color and texture: uniform light golden brown for potato chips fried with disclosed one step method (see FIGS. 17A and 17B) using disclosed seasoned oil made with finely-milled spices, non-uniform (patchy) deeper orange-brown for potato chips fried with a prior art raw spice blend by the prior art two-steps frying processing (first frying then seasoning), and pale yellow for uncoated potato chips.

These visual comparisons underscore the impact of different processing or seasoning methods on the final color of the potato chips, of the crunchy sticks and of the flat pretzels, making disclosed methods and spice blends advantageous when evaluating product quality and appeal.

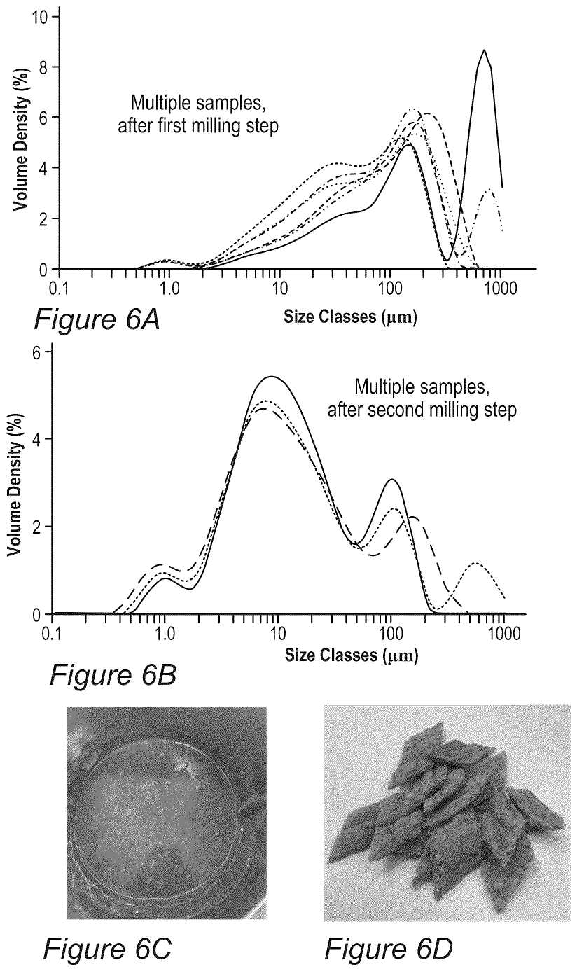

FIGS. 6A and 6B provide the particle size distributions of multiple samples after the first and second milling steps, respectively, indicating small particle size, mostly below 15 μm after the second milling step. FIG. 6C provides an image of the spicy suspension, ready to be applied to food products, after mixing the 55 wt % spice suspension with additional oil to yield required viscosity values to a specific product, namely a pea protein extruded product shown in FIG. 6D. The food product was produced by direct spraying of the disclosed spicy suspension onto the product that is being prepared, in a tumbler, using a spray gun. The mixture of spices, salt and sugar that corresponds to the specific type of product was milled in MCT oil twice, as disclosed herein. The spice mixture has been dried prior to mixing it in the oil to form the initial suspension, and the first milling step has been carried out at a more moderate profile (somewhat longer duration, and protecting the milled suspension from reaching high temperatures) than milling sugar or salt alone, in order to maintain the flavor profile of the spices. FIGS. 6A and 6B illustrate the particle size distributions after the first and second milling steps, respectively, for multiple repeats of the milling processes with different batches, under somewhat different conditions related to the drying and first milling step. All samples had a solids concentration in the suspension of 55 wt % (including salt, sugar and spices as the edible solids), and finer particles have been achieved in suspensions which have undergone two iterations of the second milling step. The particle size distribution achieved in multiple samples was characterized by D10 between 2.2-3.3 μm, D50 (median) between 11.4-12.5 μm, and D90 between 100-140 μm. Prior to the spraying on the product, the disclosed suspension was diluted in oil and with 0.3 wt % lecithin to reach a sprayable viscosity and a specified spice concentration (FIG. 6C) and applied to the extruded food product (FIG. 6D). It is noted that the spice mixture used in the testing phase included additives and was not very pure. It is expected that on an industrial scale, purer spice mixtures will improve the quality of the disclosed suspensions and allow further optimization of the disclosed preparation process.

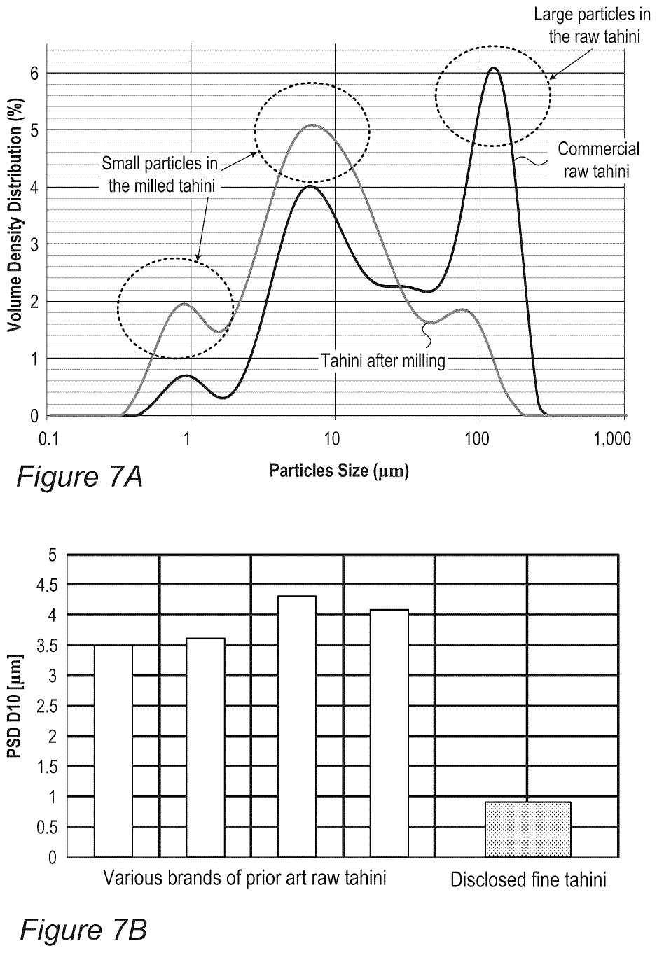

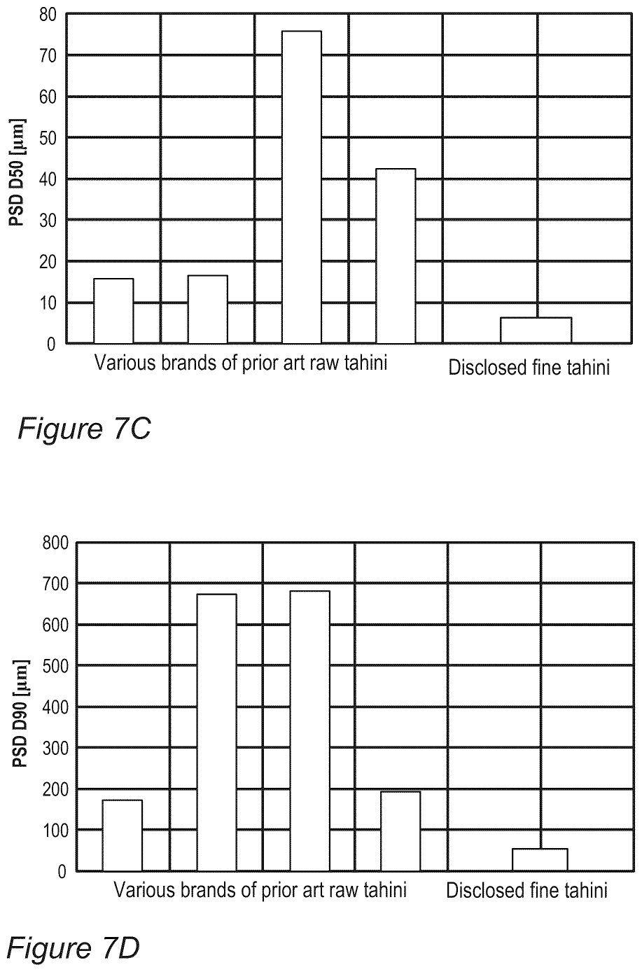

FIGS. 7A-7D provide experimental results that show the reduction in particle sizes and the changes in the PSD achieved by disclosed finely milling commercial raw tahini, according to some embodiments of the invention.

FIG. 7A provides experimental results that show the reduction in particle sizes and the changes in the PSD achieved by disclosed finely milling commercial raw tahini, according to some embodiments of the invention. The results clearly show a significant portion of the particles in the commercial raw tahini that are around 100 μm in diameter—resulting in a relatively rough texture and separation of oil and particles during storage. In contrast, after disclosed fine milling—the proportion of large particles (around 100 μm in diameter) decreases significantly, and a much larger part of the volume density distribution (%) is contributed by very small particles, having diameters around 10 μm and around 1 μm— resulting in a much smoother texture of the disclosed fine tahini and a much higher homogeneity during and following storage, which maintains the texture and lacks oil or sediment separation which characterize the commercial raw tahini.

FIGS. 7B-7D provides a comparison of the D10, D50 and D90 percentiles, respectively of the PSD between various brands of prior art raw tahini with the disclosed fine tahini, according to some embodiments of the invention.

Table 7 summarizes the comparative PSD of various brands of prior art raw tahini with the disclosed fine tahini, as provided in FIGS. 7A-7D.

TABLE 7
Comparative particle size distribution (PSD).

| | | Various brands of prior |
|---|---|---|
| Percentile | Disclosed fine tahini | art raw tahini |
| D10 | 0.9 μm | 3.5-4.3 μm |
| D50 | 6 μm | 16-76 μm |
| D90 | 54 μm | 170-680 μm |

The results demonstrate significant improvements in reducing particle sizes in disclosed embodiments compared to market-available tahini, which provide multiple organoleptic benefits, as disclosed herein.

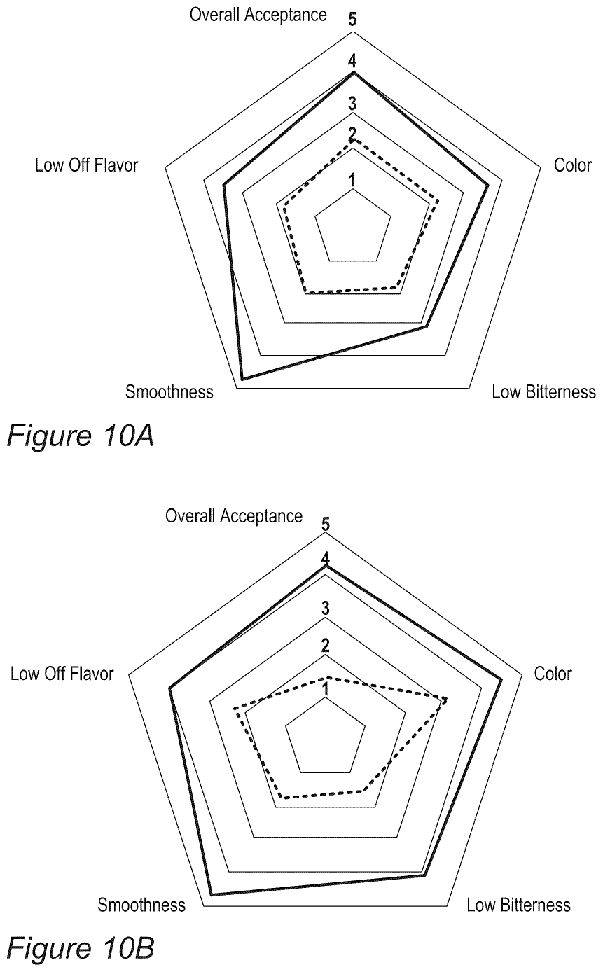

FIGS. 8A and 8B demonstrate in a visual manner the improvement achieved by disclosed fine milled tahini compared with commercial tahini, according to some embodiments of the invention. In FIG. 8A, the photograph demonstrates the separation of oil in commercial tahini, which is a common problem that occurs during storage of raw tahini. In contrast, disclosed fine milled tahini significantly diminishes oil separation, which hardly takes place. This characteristic, resulting from the finer particle sizes that maintain the particles in suspension—provides an improvement in the quality of the tahini after storage. In FIG. 8B, tahini salads made of disclosed fine milled tahini and of commercial tahini, and under the same mixture conditions (1:1 tahini and water)—are compared. The photograph demonstrates the thicker and more voluminous texture of the former due to a higher water absorption and higher viscosity, contrasted with the thin watery texture with low water absorption of the latter. The better texture provides significant benefits in the prepared products. Moreover, the tahini salad prepared from the fine milled tahini appears brighter and creamier and tastes smoother, less bitter and has less flavor compared to the tahini salad prepared from the commercial tahini (see also FIG. 10B).

FIG. 8C demonstrates in a visual manner the breaking of plant cells by disclosed milling processes, according to some embodiments of the invention. As illustrated, while commercial tahini includes plant cells that enclose their content of nutritional, taste and color compounds, the plant cells are disrupted in the disclosed milling processes and disclosed fine milled tahini has enhanced nutritional values, more enhanced taste and color due to the released compounds from the cells' internal volumes.

The breaking of cell walls disclosed herein may explain the enhancement of flavors in tahini, cocoa paste, nut butter, seeds, and various other vegetables and fruits (see, e.g., FIGS. 5G-5J, 10A, 10B and 15B), as well as the intensified color released from paprika. This release also leads to an increase in the viscosity and water absorption of tahini (see, e.g., FIGS. 8B, 9A and 11B), due to the proteins released or changes in their structure, resulting in an improvement and intensification of its flavor (see, e.g., FIGS. 5G-5J, 10A and 10B).

The inventors have found out that this effect is general for many types of ductile plant materials, including various spices and grains—yielding enhanced nutritional values of the former and enhanced taste and color of the latter—as disclosed herein. Disclosed fine milling in oil therefore enhances the effects of spices by releasing more active ingredients that are otherwise, in prior art technology, kept inaccessible within plant cells, in addition to the effect of milling to reduce particle sizes of crystalline particles beyond the possibilities of prior art technology, and enhance their taste, possibly due to the achieved increased cumulative surface area.

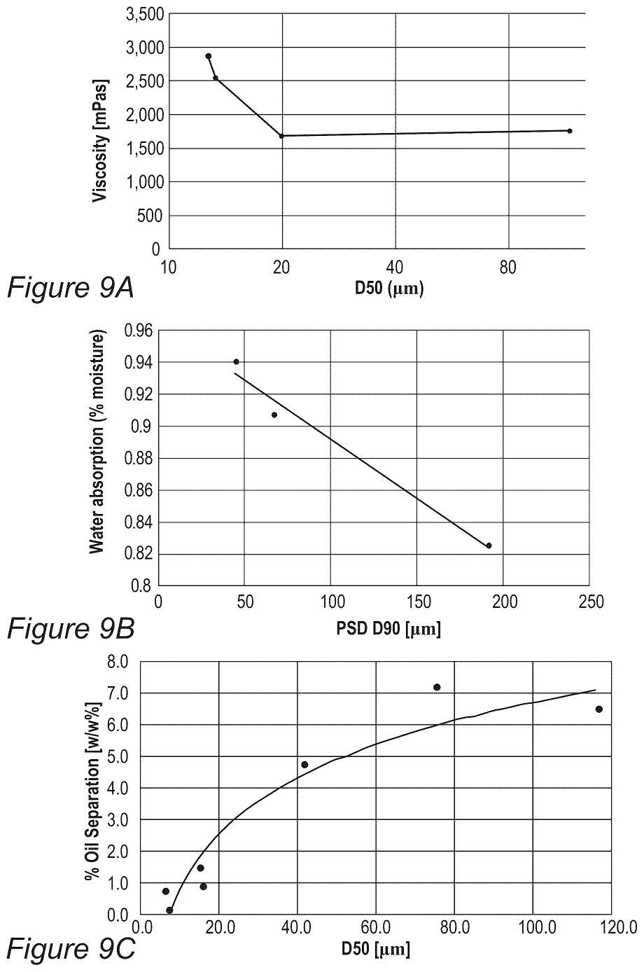

FIGS. 9A-9C provide graphs that illustrate the improvement of multiple characteristics achieved in disclosed finely milled tahini, according to some embodiments of the invention. FIG. 9A illustrates the increase in viscosity achieved under D50 of 20 μm and accelerating under D50 of 15 μm. FIG. 9B illustrates the increase in water absorption capacity with decreasing D90. D90 values below 90 μm, e.g., the measurements around 50 μm, correspond to the disclosed fine tahini, while D90 values above 90 μm, e.g., the measurements around 200 μm, correspond to prior art commercial tahini.

As particle size decreases, greater water absorption is facilitated, enhancing the applicability of tahini in final products. FIG. 9C illustrates the reduction in oil separation (see FIG. 8A) with decreasing D50, especially as D50 decreases below 15-20 μm. As particles decrease in size, oil separation decreases, improving the storability of the product (irrespective of shelf life). The correlation was good, with % Oil separation=2.6·ln D50−5.3, R²=0.93.

FIGS. 10A and 10B demonstrate the improved organoleptic characteristics of disclosed finely milled tahini compared with commercial tahini, according to some embodiments of the invention. FIG. 10A illustrates results for finely milled raw tahini and FIG. 10B illustrates results tahini salad prepared (mixing 150 gr Tahini, 200 gr water and 2 gr salt) from finely milled raw tahini—both compared with the corresponding commercial tahini and tahini salad prepared therefrom. Each test was conducted by 20 professional tasters, and the overall scores were 18.8 for disclosed finely milled tahini compared with 10.3 for commercial tahini, and 21.3 for tahini salads made of disclosed finely milled tahini compared with 10.3 for tahini salads made of commercial tahini. It is noted that both products are superior to prior art products in all evaluated parameters—including overall acceptance, color, low bitterness, smoothness and low off flavor, with products made of disclosed fine tahini ranking one to three evaluation grades (out of five) above corresponding products prepared from commercial raw tahini. It is noted that similar results are expected for other tahini products, with the improved organoleptic characteristics of the disclosed finely milled tahini contributing to improve products such as sauces, dips, dressings, spreads such as hummus, confections such as halva, etc.

FIG. 11A provides a comparison of oxidation values of commercial raw tahini and disclosed fine tahini, according to some embodiments of the invention. The data is given in TOTOX (total oxidation) values and indicates that the disclosed processing of the raw tahini to yield fine tahini does not cause any degradation of the prepared tahini.

FIG. 11B provides data depicting the changes in viscosity of tahini as water concentration in the mix changes, comparing commercial raw tahini with disclosed fine tahini, according to some embodiments of the invention. In the disclosed fine tahini the viscosity rises very quickly beyond 0.8:1.0 (44%) tahini in water and reaches a peak or inflection point at 1:1 (50%) tahini with water. At the same time the reference commercial tahini's viscosity increases insignificantly as tahini concentration increases beyond the 0.8:1.0 tahini in water concentration. The disclosed tahini with a viscosity of ˜35,000 mPa/s at 1:1 ratio with water compared to only 500 mPa/s of the reference tahini at 1:1 ratio with water can then be used at much lower concentrations in tahini-based salads (like humus salad) while maintaining the high viscosity and texture expected from high quality tahini based salads like humus tahini salad. The different viscosities of tahini water mixes is in correspondence, e.g., with the photo in FIG. 8B, the general graph of FIG. 9A and with the improved organoleptic characteristics indicated in FIG. 10B concerning the improved smoothness. For example, disclosed finely milled tahini reaches a viscosity of 18,000 mPa/s already at 0.8:1 (tahini to water) ratio while commercial tahini reaches that viscosity only at 1.5:1 (tahini to water) ratio—requiring about a double amount of tahini to hold the same amount of water. These results are consistent with the understanding presented herein, that as particle size decreases, greater water absorption is facilitated, thereby enhancing the applicability of disclosed fine tahini in final products compared to commercial products.

Advantageously, the disclosed fine tahini also provide storage benefits compared to commercial raw tahini, including less or no oil separation and less or no development of rancidity—probably due to the finer texture and higher degree of homogeneity achieved through the fine milling.

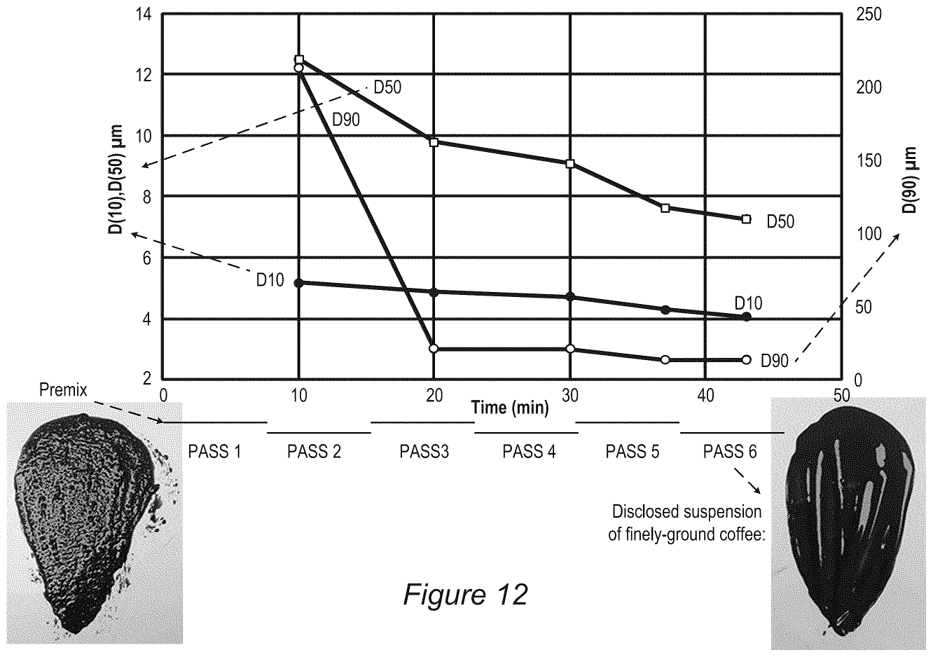

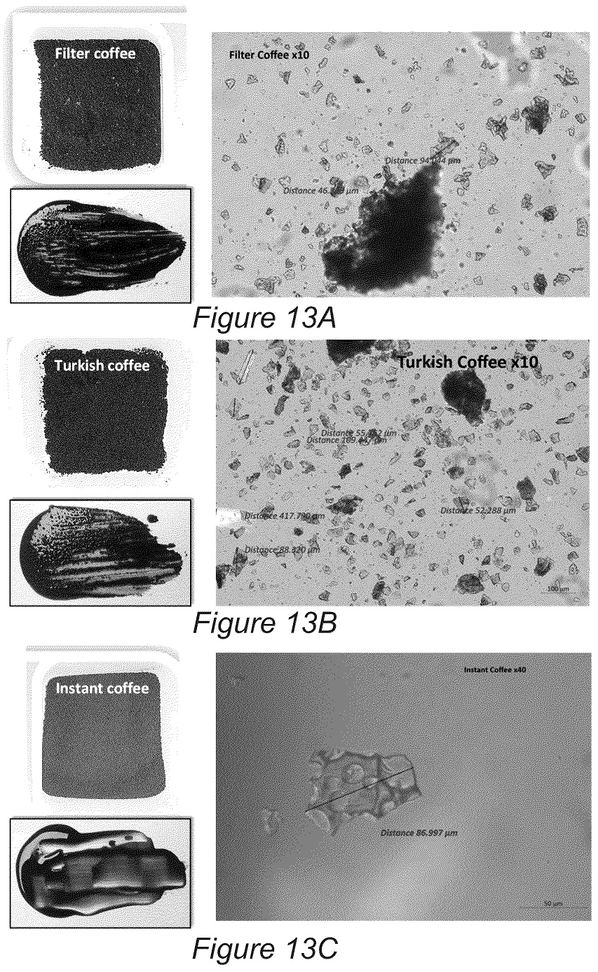

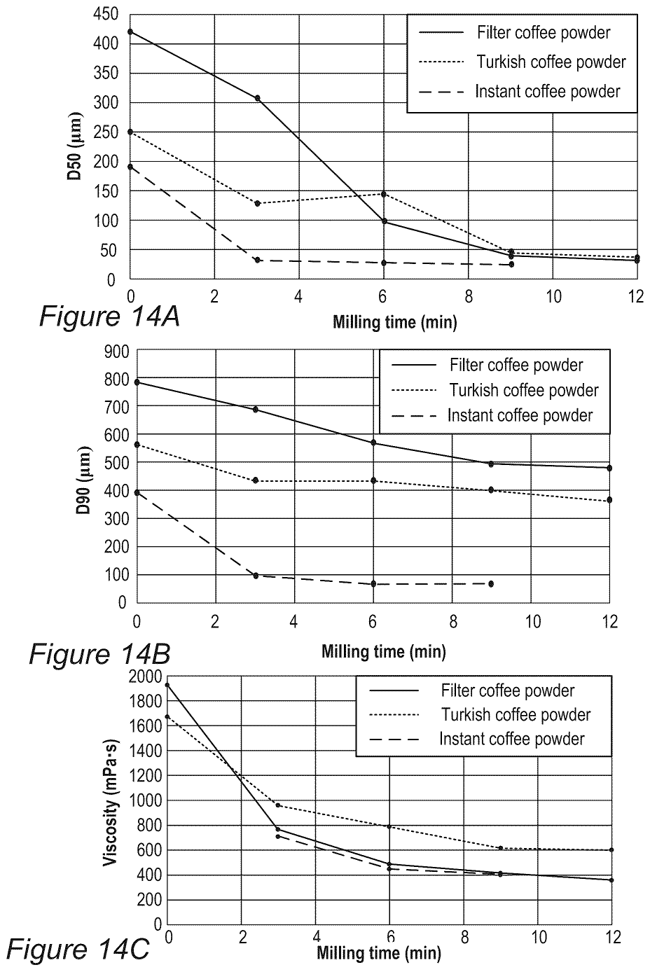

FIG. 12 provides experimental results showing the reduction in particles sizes and the changes in the particle size distribution with successive passes through the milling step, according to some embodiments of the invention. The milling step corresponds to second particle size reduction step 90B, and is applied to the premixes which are prepared by initial milling of an oil suspension of the coffee powder in a kitchen blender to yield the suspension and provide an initial reduction in particle sizes that corresponds to first particle size reduction step 90A illustrated schematically in FIG. 1A (see FIGS. 13A-13C and 14A-14C for details concerning the preparation of the premixes).

FIG. 12 illustrates the reduction in the D10, D50 and D90 percentiles, from ca. 4 μm, ca. 40 μm and ca. 235 μm— to ca. 1 μm, ca. 7 μm, and ca. 45 μm, respectively (see FIGS. 14A and 14B for comparison with the prior art data)—hence disclosed methods yield a reduction in particles size over the PSD by factor of 4 to 5 (additionally, the D100 percentile was reduced from ca. 1100 μm to ca. 140 μm, reducing the graininess significantly). The images in FIG. 12 illustrate visually the change from the fine-grained premix (prior art Turkish coffee)—to the smooth finely-milled disclosed coffee suspension—corresponding to the achieved improvement in texture, as well as corresponding to the achieved enhancement of taste. While the experimental results in FIG. 12 are for six passes, gradually reducing the particle sizes in the suspension, it is noted that the multiple passes were carried out for experimental reasons, and that a commercial process is optimized (with respect to the various milling parameters) to be carried out in a single pass, to enhance its efficiency.

FIGS. 13A-13C provide images of powders, particles and premixes in oil of three types of coffee. Filter coffee (FIG. 13A) comprises roasted and coarsely-grained coffee beans for preparation using a paper filter and without water pressure, at lower temperatures. Turkish, or black coffee (FIG. 13B) comprises finely-ground roasted coffee beans, prepared in boiling water. Instant coffee (FIG. 13C) comprises spray- or freeze-dried boiled coffee made of finely-milled roasted coffee beans—resulting in a powdery (dried) extraction. Each one of FIGS. 13A-13C illustrates a general view of the respective coffee powder, a microscopic image at ×10 magnification showing the size and form of the coffee particles, and respective smears of premixes of the respective coffee powders in MCT oil, illustrating the texture and graininess of each type of coffee. Specifically, filter coffee (FIG. 13A) is characterized by a broad range of particle sizes as well as particle agglomerates, Turkish coffee (FIG. 13B) is characterized by a wide range of particle sizes as well as by residues of organic materials, and instant coffee (FIG. 13C) is characterized by porous particles having a wide range of particle sizes. Typical particle sizes in all three coffee types are between 5000-850 μm, as illustrated by several measurement on each image. The texture of the oil suspensions (pre-mixes) of the three coffee types is grainy for filter coffee (FIG. 13A) and Turkish coffee (FIG. 13B), and smooth for instant coffee (FIG. 13C). Coffee concentrations in the oil suspension were 50 wt % for filter coffee and Turkish coffee, and 40 wt % for instant coffee—due to its low density the lower ability to blend the latter in oil. FIGS. 14A and 14B provide corresponding particle size distributions (D50 and D90 percentiles, respectively) of the three types of coffee, as measured during milling the respective coffee-oil suspensions in a kitchen blender to form the respective pre-mixes, according to some embodiments of the invention. During the milling to form the pre-mixes, the particle sizes were reduced mainly through interactions with the blender's blades, corresponding to first particle size reduction step 90A illustrated schematically in FIG. 1A. The D50, D90 and D100 percentiles were measured every three minutes using Mastersizer™ 3000 measurement instrument, and are shown in the graph—decreasing in filter coffee from ca. 400 μm to ca. 30 μm for the D50 percentile, in Turkish coffee from ca. 250 μm to ca. 40 μm for the D50 percentile, and in filter coffee from ca. 200 μm to ca. 35 μm for the D50 percentile (FIG. 14A); and decreasing in filter coffee from ca. 800 μm to ca. 500 μm for the D90 percentile, in Turkish coffee from ca. 550 μm to ca. 350 μm for the D90 percentile, and in filter coffee from ca. 400 μm to ca. 70 μm for the D90 percentile (FIG. 14B). Additionally, some oil separation was observed, or 3.8 w/w % and 3.4 w/w % in filter coffee and Turkish coffee, respectively, and reaching 16.9 w/w % oil separation in instant coffee, in line with the lowed suspendability of instant coffee in oil, which corresponds to the different type of particles it comprises (see FIGS. 13A-13C). Finally, FIG. 14C provides results of viscosity measurements at room temperature using a rotary digital viscometer (MRC) VIS-5™, indicating the decreasing viscosity with finer milling, probably related to the degree of agglomeration and possibly associated moisture content—which were highest in Turkish coffee (see also FIGS. 13A-13C).

In comparison of the three types of coffee powders, it is noted that the milling process can be effectively implemented using Turkish and filter coffee at a solid concentration of 50 wt %. Milling instant coffee was shown to require modifications due to its high volume-mass ratio, resulting in a significantly larger volume for the same mass of coffee. Consequently, the attainable solid concentration for instant coffee was limited to 40 wt %, and the process may be adjusted to reduce oil separation. Concerning instant coffee it is noted that the disclosed grinding process is primarily employed to enhance yield, mitigate depreciation, minimize sedimentation, and optimize its efficacy in complex emulsions within the industry.

Accordingly, in various embodiments, a coffee powder may be premixed in oil to form a coffee in oil suspensions, and milled to reduce the particles sizes (first particle size reduction step 90A illustrated schematically in FIG. 1A) as illustrated in a non-limiting example in FIGS. 14A and 14B. Consecutively, the respective premix may be further milled to further reduce the particle sizes by a different type of milling (second particle size reduction step 90B illustrated schematically in FIG. 1A, involving particle-particle interactions and/or particle—milling media interactions, rather than particle-rotor interactions as in first particle size reduction step 90A.

In various embodiments, the types of oils used for the coffee in oil suspensions may include cocoa butter, MCT oil, Ghee butter, palm oil, high olein palm oil, hazelnut paste, milk butter, milk fat, refined coconut oil, sunflower oil, canola oil, soy oil (all in liquid phase, melted if needed) or animal fats like tallow, lard, duck fat, chicken fat etc. in their molten liquid form.

Ground roasted coffee beans are approximately 30% to 40% soluble in water, and hence retains most coffee solids are retained during brewing. Advantageously, disclosed embodiments meet one of the most significant challenges faced by the industry—of creating a stable suspension to reduce the requisite quantity of coffee to achieve the desired flavor profile. While in the prior art—as particles decrease in size, they are suspended and float within the coffee cup, diminishing the sediment after consumption and augmenting the overall flavor—disclosed embodiments enable improved texture and taste extraction as disclosed herein.

Disclosed embodiments deviate from the traditional dry milling process, as the sizes of the coffee particles are reduced by about an order of magnitude further than the finest milled prior art coffee—enabled by the use of coffee in oil suspensions. It is noted that disclosed finely-milled coffee in oil suspensions may be used in a wide range of products and applications, such as coffee-filled cookies or coffee-flavored ice creams, in which the suspension in oil has further advantages compared to prior art water extractions of coffee. Specifically, the disclosed finely-milled coffee in oil suspensions can be mixed in the oil phase in various food products and/or be used in water-based applications or emulsions—enhancing the possibility to incorporate coffee in various food products (the solubility of prior art ground coffee is low in both water (e.g., only 30-40% soluble in water) and oil, into various food products—allowing for a more comprehensive integration of coffee properties in the food products. Moreover, the taste profile of the finely-milled coffee is accentuated and richer than achievable by prior art coffee extracts which have much larger particle sizes.

Non-limiting examples for food products in which the disclosed finely-milled coffee in oil suspensions may be used include the following, possibly without addition of coffee extract other than the disclosed suspension: Coffee-flavored chocolate products of any type, coffee-flavored ice cream products of any type, coffee-flavored cream, pudding and/or spread products of any type, coffee-flavored milk-based products of any type, coffee-flavored drinks and/or confectionery products of any type.

Advantageously, emulsions of disclosed oil-based coffee suspensions may be used in various products (e.g., by mixing, whipping, etc.) to provide maximal taste extraction, compared with the limited taste provided by prior art ground or instant coffee powders, which are limited by the partial solubility of the coffee ingredients in water. Additional advantages include simpler packaging, transportation and serving, as disclosed finely-milled coffee in oil suspensions are inherently resistant to molds and oxidation, as the coffee ingredients are protected by the oil from humidity, liquid water and air, do not require a special packaging atmosphere (e.g., nitrogen in packages coffee powder) and can be easily dosed, e.g., by pouring, using a pressure bottle or any other form of liquid dispensing.

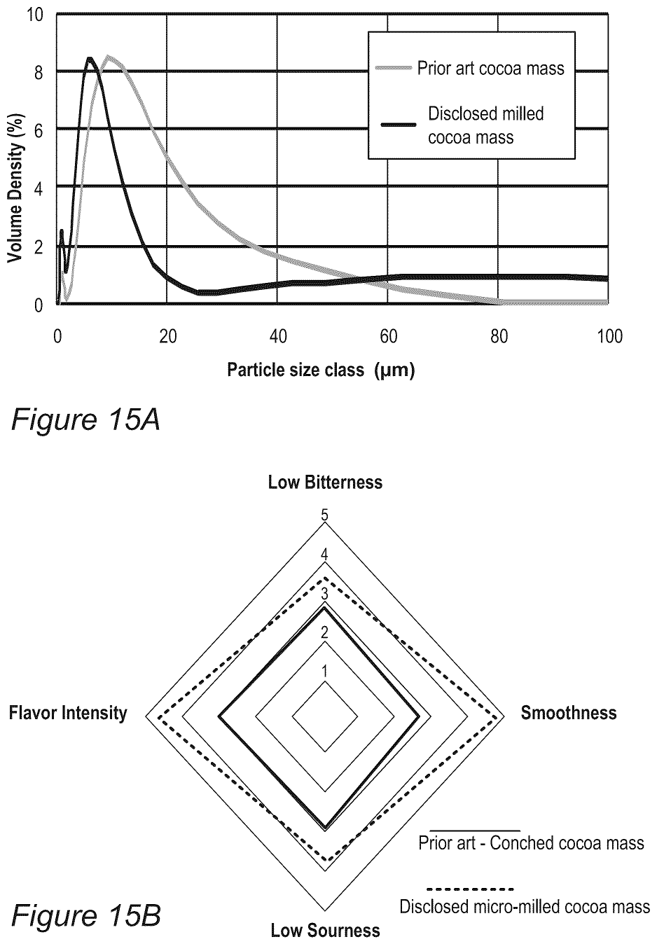

FIGS. 15A and 15B provide a particle size distribution and product evaluation, respectively, of cocoa mass, according to some embodiments of the invention. Cocoa mass provides another example of the applicability of the disclosed micro milling to enhance the taste and flavor of edible solids, potentially reducing raw material usage and lowering industry costs or providing a better organoleptic experience.

Raw, unprocessed cocoa mass (prior art cocoa mass) was milled as disclosed herein, melting the cocoa mass without additional carrier oil, functionally provided by the liquefied cocoa butter in the cocoa mass. Disclosed milling was shown to modify the particle size distribution of cocoa particles—reducing the median particles size (D50) from 9.94 μm to 5.72 μm and modifying the volume density distribution as illustrated in FIG. 15A. Furthermore, a tasting assay (FIG. 15B, including eight experienced tasters, in a blind test) indicates significant improvements across all tested parameters. The most noticeable effect is the improvement in the texture of the cocoa mass—achieving a smoother and creamier texture, which plays a crucial role in consumer preference in chocolate and overall product quality within the chocolate industry. In addition, the flavor was enhanced significantly, reducing bitterness and sourness by applying the milling process disclosed herein— resulting in a richer and more satisfying taste. The overall improvement achieved by the disclosed milling is reflected in the overall score (sum of sub-scores) reaching 16.7 for disclosed finely-milled coca mass, versus a score of 11.2 for prior art cocoa mass.

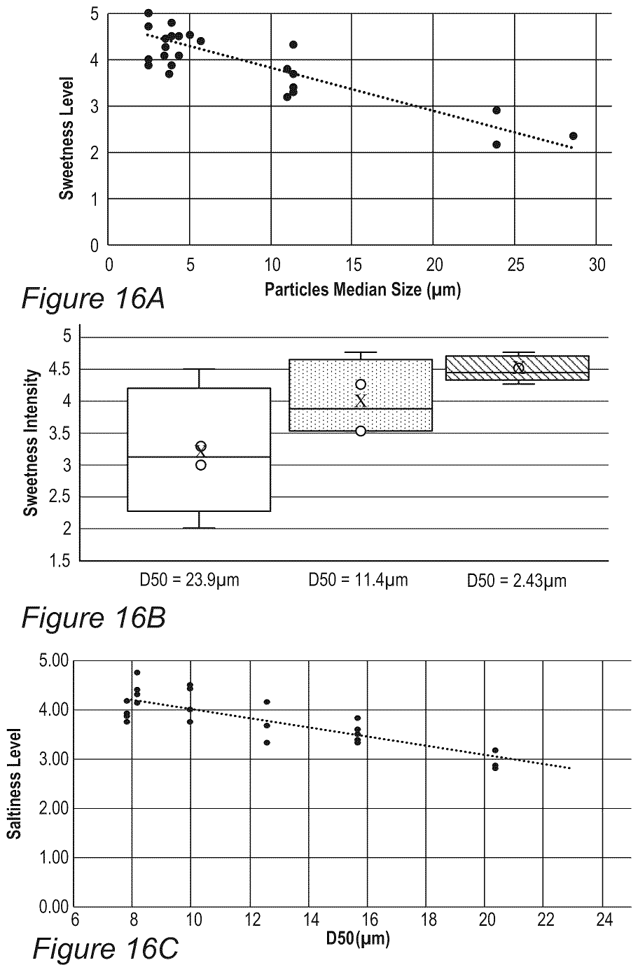

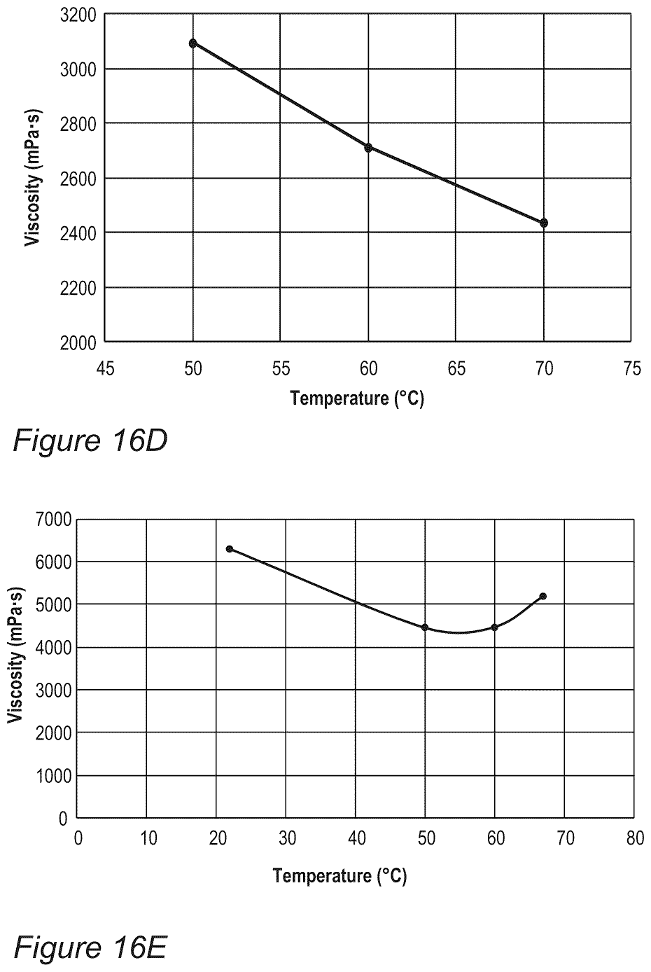

FIGS. 16A and 16B provide assessments of enhanced sweetness in products including milled sugar as disclosed herein, according to some embodiments of the invention. Sweetness level in FIGS. 16A and 16B was assessed by six persons on a trained sensory panel, in a blind test, on a scale of sweetness intensity ranging from 1 (not sweet) to 5 (very sweet) with respect to a reference sample rated as 4, and each point represents the mean sweetness intensity rating by the sensory panel for specific samples of suspensions of 20 wt % micronized sugar in oil (FIG. 16A) and specific samples of vanilla ice cream made with suspensions of 10 wt % micronized sugar in oil having different particle size distributions (FIG. 16B), as disclosed herein. In FIG. 16B, the boxes represent the interquartile range (IQR), the horizontal lines indicate the median, “X” indicates the average, and the whiskers extend to the minimum and maximum values.

FIG. 16A illustrates a positive correlation (R²=0.73) observed between particle size and sweetness intensity. FIG. 16B demonstrates a consistent trend in which smaller particle sizes correspond to greater sweetness. The trend is demonstrated for ice cream in FIG. 16B, and was found also for cookies and sweet sesame spreads. Moreover, FIG. 16B demonstrates that the narrower the particle size distribution becomes, the more consistent are the sweetness ratings. Hence, the smaller particles do not only enhance the perception of sweetness but also lead to more consistent evaluations among different tasters. It was further found that oils with lower melting temperatures were more efficient in enhancing sweetness due to the milled particles, probably by enhancing taste perception.

FIG. 16C provides assessments of enhanced saltiness in products including milled salt as disclosed herein, according to some embodiments of the invention. The level of saltiness was assessed by seven persons on a trained sensory panel, in a blind test, on a scale of saltiness intensity ranging from 1 (not salty) to 5 (very salty) with respect to a reference sample rated as 4, and each point represents the mean saltiness intensity rating by the sensory panel for specific samples of suspensions of micronized salt in oil, having 12 wt % salt. FIG. 16C demonstrates a strong correlation (R²=0.70) between the saltiness level and the D50 (median) of the particle size distribution.

FIGS. 16D and 16E provide temperature-dependent viscosity measurements of disclosed suspensions of milled salt and of milled spices, respectively, according to some embodiments of the invention. FIG. 16D provides results of 50 wt % salt in palm oil indicating declining viscosity with elevated temperature, and FIG. 16E provides results of 55 wt % spices (grill mixture, barbeque flavored) in high oleic sunflower oil (HOSO) oil composition (including at least 80 percent oleic acid (monounsaturated), indicating an initially declining and then increasing viscosity with elevated temperature. These results suggest that there is an optimal processing temperature at a relatively low viscosity that simplifies handling, e.g., enables efficient pouring or spraying.

In various embodiments and products, one step milling was compared to two step milling with respect to the resulting particle size distribution and viscosity. It was found that in general, at least two milling steps are required to reach a median particle size below 10 μm. Suspensions and products that were examined include sugar and salt suspensions in MCT, HOSO and olive oils, spices (grill mixtures) suspension in HOSO oil, various syrups including fructose in MCT oil, chocolate and peanut syrups, as well as coffee suspensions in MCT oil—with solid concentrations ranging between 40 wt % and 76 wt %. The first milling step resulted in D50's between 17.1 μm and 48.2 μm while two milling steps resulted in D50's between 3.4 μm and 8.3 μm. It is noted that the D50's after the first and second milling step do not necessarily correlate, as, e.g., chocolate syrup having a high D50 after the first milling step (48.2 μm) had a low D50 after the second milling step (3.95 μm).

Some embodiments of the present invention provide efficient and economical methods and mechanisms for preparing fried and seasoned food products and thereby provide improvements to the technological field of food manufacturing and preparation, and food quality. Methods are provided for preparing seasoned fried food products, in which the food products are fried in a heated oil suspension of micronized edible particles (e.g., salt, spices, sugar) having diameters within a range of 1-15 μm or in 1-10 μm (median value—D50 percentile of the particle size distribution—PSD).

Frying and seasoning are carried out in a single step to yield a fine and uniform coating of the salt microparticles (and optionally spices and/or sugar microparticles) that enhances the tastes and their persistence, and also enables to reduce the amount of salt (and/or sugar or spices) that are required to achieve a specified taste goal. Corresponding fried and uniformly seasoned food products are provided, such as crisps, chips, nuts, meat, vegetables, dumplings and/or tempura.

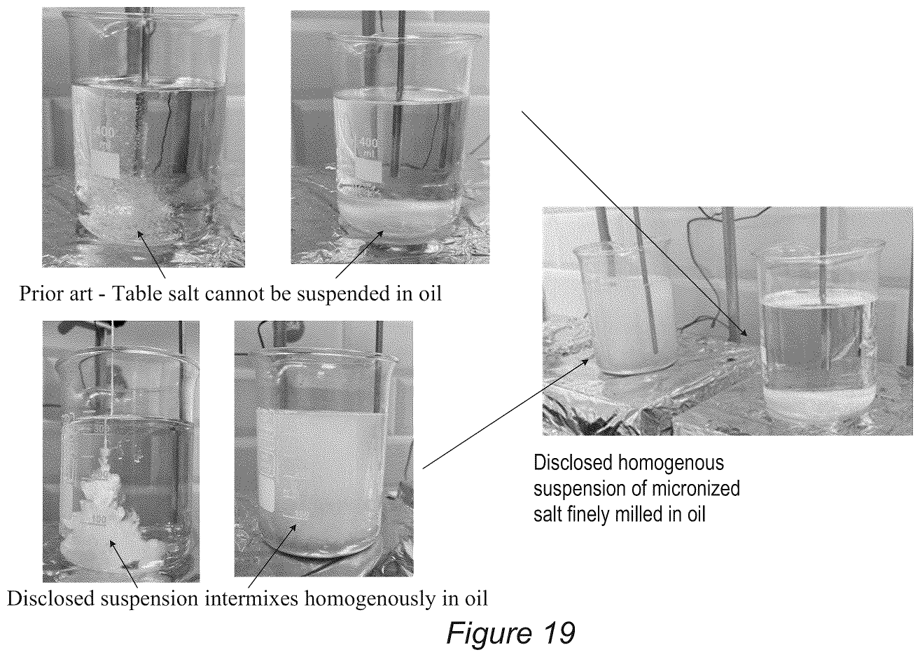

The oil suspension of micronized edible particles may be produced by micro-milling salt crystals or other edible particles, as disclosed herein, e.g., in FIG. 1A. The inventors have found out that micro-milled salt crystals with sizes in the order of magnitude of 1-15 μm or 1-10 μm (D50 percentile of the PSD)—are spontaneously suspended in warm oil by vertical convection eddies which normally exist in hot liquids (see comparative FIG. 19). This stands in contrast to regular salt crystals, typically used for seasoning fried food products, which have sizes (e.g., particle diameters) in the order of magnitude of 50-200 m forming a salt powder that, even when suspended in oil—immediately sinks to the vessel floor if not actively agitated. In contrast—the disclosed suspension of micro-size particles evenly distributed in the oil provides for intimate and homogenous contact of the solid particles with the surface of the food product. The suspension of micronized salt in oil is visible as a white cloudy oil due to multiple light scattering centers of micro-sized particles.

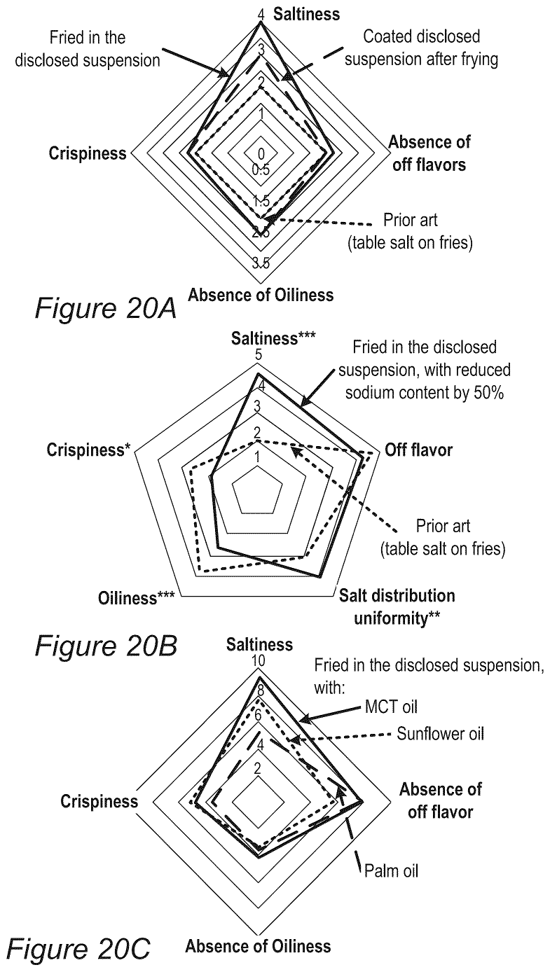

Moreover, the inventors have found out that the small particle size provides strong adhesion of the particles to the surface of the food product, which prevents the micro particles from falling off the food product during handling and in the packaging. In many cases, the very small particles are smaller than the natural pores in some food products like potato crisps and chips and applying the oil suspension onto the food products carries the micronized salt particles directly into the pores in the food product—thereby providing a long lasting salty effect when chewing the food product (in contrast to normal salting by surface sprinkling that yields a salting effect on the surface only). This is especially important when salting relatively bulky food products (with a relatively small surface area to volume) like thick potato chips, meat, vegetables and other porous fried foods. Experimental tasting results (see FIGS. 20A-20C) indicate the improved organoleptic and nutritional characteristics of disclosed food products compared to the prior art.

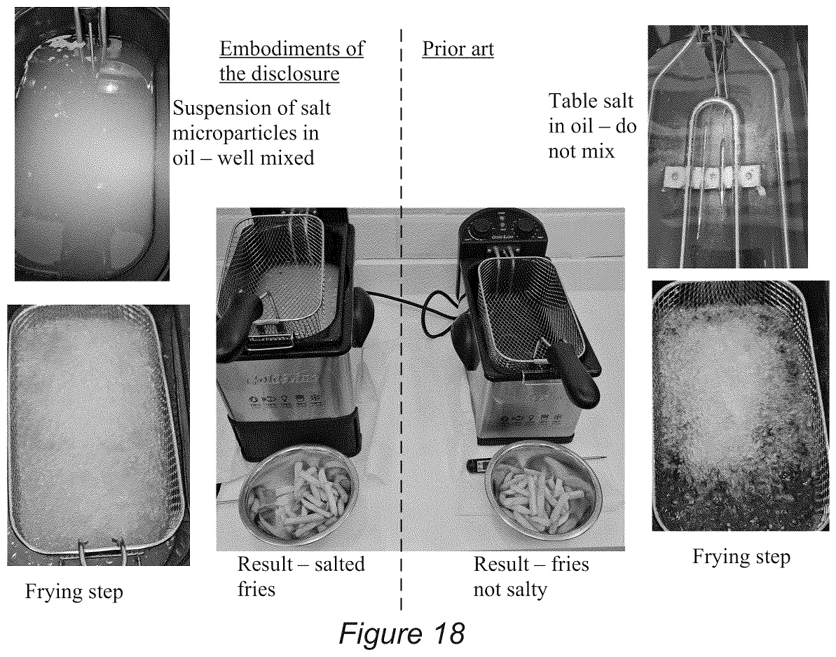

In experiments provided herein, the inventors have found out that the spontaneous suspension of micron sized particles in oil is temperature-dependent, beginning at about 100° C. and increasing with temperature until thorough suspension is reached at normal frying temperatures of 150-180° C. The effect is enhanced with lower viscosity oils compared to heavier oils. For example, heavier oils like sunflower oil require higher temperatures to suspend the particles while lighter oils like MCT require lower temperatures. For example, applying disclosed methods to fry and season potato chips and French fries (see, e.g., FIG. 18) indicate that the effect of salting continues for a long time and multiple frying rounds in the same oil as long as the oil is kept warm. It was noted that while cooling the oil suspension below 100° C. resulting in the gradual sinking of the salt microparticles to form a soft sediment on the vessel floor, turning the oil transparent—re-heating the oil to about 150° C. re-forms the suspension spontaneously. Slight stirring was found to enhance the re-suspension of the microparticles, enabling reusing the oil suspension to fry and salt further food products.

FIGS. 17A and 17B are a high-level flowchart and a schematic diagram, respectively, illustrating methods 200 of preparing a seasoned fried food product, according to some embodiments of the invention. Method 200 may comprise the following stages, from either FIG. 17A or 17B, irrespective of their order.

For example, as illustrated schematically in FIG. 17A, method 200 comprises frying the food product in a heated oil suspension of micronized edible particles (stage 210), wherein the heated oil suspension of micronized edible particles comprises salt and/or seasoning microparticles within a median diameter range of 1-15 μm or 1-10 μm (D50 percentile of the PSD). The heated oil suspension of micronized edible particles may further comprise microparticles of spices and/or sugar within a median diameter range of 1-15 μm or 1-10 μm (D50 percentile of the respective PSD). Method 200 may further comprise heating and/or agitating the oil to suspend the micronized edible particles (stage 215). Method 200 may be carried out in a single frying step, without applying further seasoning (stage 220).

For example, as illustrated schematically in FIG. 17B, method 200 comprises the steps of: (1) heating frying oil in a container, e.g., to 150-180° C. (stage 250), (2) adding the micronized salt oil suspension (see, e.g., suspension 130 in FIG. 1A) (stage 255), with the oil used to form the suspension being the same or different type of oil compared with the type of the frying oil, (3) adding the food products to the mixture and frying them therein (see, e.g., FIG. 18) (stage 260), (4) removing the fried and salted food products from the frying oil (stage 265), and repeating the frying steps (stages 260 and 265) to fry additional food products, optionally topping up the frying oil and/or the micronized salt oil suspension as required (stage 270).

In some embodiments, the concentration of micronized salt oil suspension 130 may be between any of 1-70 wt %, 30-70 wt %, 40-60 wt %, around 50 wt %, or any other intermediate value. In step (2) of adding suspension 130 to the frying oil (stage 255), the amounts may be set to yield a resulting salt concentration in the mixture between 0.5-10 wt %, possibly around 3 wt % or any intermediate value—configured to reach a given degree of salting of the food products (e.g., around 1 wt % or any other specified value). If spice and/or sugar particles are also suspended in oil suspension 130, their amounts and the proportions of the mixture may also be configured with respect to the specified final content of the fried food products. If needed, the mixture of suspension 130 and the frying oil may be slightly agitated and/or mixed to support homogeneous mixing of suspension 130 and the frying oil and corresponding homogenous distribution of the suspended micronized salt particles throughout the oil mixture. Typical frying times are not changed, e.g., around three minutes for thin crisps, between 2-8 minutes for pre-cooked French fries, or about 10-15 minutes for fresh potato chips.

For example, method 200 may be applied using a low-viscosity oil to suspend the salt particles, e.g., oil having a viscosity below 25 cP, such as MCT (medium-chain triglyceride) oil.

In some embodiments, disclosed method 200 may be used to directly fry the food products in the oil suspension of micronized edible particles, replacing or augmenting regular oil in various fried food preparation systems with the oil suspension of micronized edible particles. Using the disclosed oil suspension of micronized edible particles makes an additional seasoning step redundant—saving costs and improving the quality of the resulting food products.

Methods 200 thus produce fried food products that are coated with salt and/or seasoning microparticles within a median diameter range of 1-15 μm or 1-10 μm (D50 percentile of the PSD). The fried food products may be optionally further coated with microparticles within a median diameter range of 1-15 μm or 1-10 μm (D50 percentile of the PSD) of spices and/or sugar—suspended in oil and applied together with the salt microparticles. For example, the fried food products may comprise crisps, chips, nuts, meat, vegetables, dumplings and/or tempura.

Referring to FIG. 1A, it is noted that resulting from the process is oil suspension 130 of micronized edible particles within a median diameter range of 1-15 μm or 1-10 μm (D50 percentile of the PSD), that forms a thixotropic fluid which may be thick or viscous under static conditions, but flows upon application of various forces (e.g., agitations, shaking, shear, or otherwise stressed). Thus, the flow of the oil suspension of micronized edible particles may be controlled by applying corresponding forces, e.g., introducing a concentrated suspension into additional oil to form the suspension used for frying, as disclosed herein.

FIG. 18 provides an experimental comparison of mixing salt in oil and frying French fries therein, according to some embodiments of the invention. Initially, regular table salt does not mix in oil, and as a result, frying in the oil yield unsalted fries (demonstration of the prior art)—which require the application of an additional seasoning step. In contrast, in disclosed embodiments, the oil suspension of micronized salt mixes well in oil (heavier oils may require light heating and/or agitation to enhance the mixing), and frying in the suspension yields one-step fried and seasoned, salted fries. It is noted that the salt microparticles remain suspended in the oil after frying, enabling frying of additional products.

In various embodiments, the demonstrated domestic scale frying may be replaced by industrial scale frying, using the disclosed oil suspension of microparticles (salt, and possibly spices and/or sugar) instead or regular frying oil, and thereby making the additional prior art step of seasoning the food product—redundant. Disclosed embodiments thereby simplify the production process, reduce costs and complexity, and yield improved products with enhanced taste and longer shelf life.

For example, considering various prior art fried and seasoned food products, the following advantages are provided by disclosed embodiments:

Fried potato chips (crisps) or regular chips (French Fries)—the prior art two-step process includes preparing the chips, frying the chips (e.g., in a batch or continuous frying machine), drying the chips after frying from excess oil and sprinkling a solid salt powder on the surface of fried chips as evenly as possible. The sprinkling operation requires spreading out the fries and finely tuning the sprinkling of salt powder to achieve even results, and resulting in one-sided salting—taking a significant extent of mechanical manipulation, space and time, exposing the chips to contamination and reducing throughput. Moreover, water adsorption and clumping reduce shelf life, and the products are unevenly salted. In contrast, disclosed embodiments enable a single step frying and salting, dismissing with the sprinkling stage altogether, and achieving a better product—more evenly salted, with enhanced taste and reduced amount of salt, and with longer shelf life.

Fried nuts (e.g., peanuts)—the prior art two-step process includes preparing the nuts, frying the prepared nuts (e.g., in a batch oil kettle with rotating blades), de-oiling the fried nuts in a centrifuge and then transferring the nuts to a salting drum—in which salt is added to the drum while it is spinning and the salt adheres to the peanut surface with the oil acting as an adhesive. The prior art salting step has several disadvantages, such as forming a non-homogenously salted product as the salt particles are heavy and fall off the nuts, requiring a thick layer of oil to bond the salt to the nut surface as a high sodium content for reaching a tasty salty effect. In contrast, disclosed embodiments enable a single step frying and salting, dismissing with the salting station altogether, and achieving a better product—more evenly salted, with enhanced taste and reduced amount of oil and salt, and with longer shelf life.

Bulky fried food products— meat, vegetables, dumplings, tempura, etc. The prior art requires a salting or seasoning step after frying, which requires relatively large amount of salt and spices due to the smaller ratio of surface area to volume in these products. Disclosed embodiments provide salting and seasoning during the frying step, saving equipment and a process step compared to the prior art. It is noted that in industrial food processing, the production footprint is a very expensive resource, involving significant installation and operation costs, with a large footprint potentially increasing contamination of the products. In contrast, disclosed embodiments enable a single step frying and salting, dismissing with the salting or seasoning steps altogether, and achieving better products—more evenly salted, with enhanced taste and reduced amount of oil and salt, and with longer shelf life. It is noted that the enhanced taste is of particular importance in bulky food products, and results from the smaller salt microparticle sizes (having larger surface areas with respect to salt volume), from the isolation of the salt microparticles within the oil suspension from humidity—preventing agglomeration, avoiding use of additives, and more even spread (due to immersion of the food product in the suspension) and adherence of the smaller particles to the food products.

Moreover, disclosed embodiments enable salting porous foods like potatoes, meat and dough-based foods—on the outside as well as internally. The internal salt provides a longer lasting and smoother salty effect which also allows reduction of the sodium required for reaching a satisfying salty effect.

In various embodiments, the types of oils used for the oil suspensions may include cocoa butter, MCT oil, Ghee butter, palm oil, high olein palm oil, milk butter, milk fat, refined coconut oil, sunflower oil, canola oil, soy oil (all in liquid phase, melted if needed) or animal fats like tallow, lard, duck fat, chicken fat etc. in their molten liquid form—as long as the frying temperature is high enough to cause convection eddies that brings the microparticles into suspension (see, e.g., FIG. 18). Alternatively or complementarily, agitation or mixing methods may be used to provide a stable homogeneous suspension. Various embodiments include mixing different types of oils to yield the suspensions, for example using MCT oil as the carrier oil for the salt microparticles and sunflower oil as the main frying oil. Mixing the suspension of salt microparticles in MCT oil into the sunflower oil yields the disclosed oil suspension of salt microparticles that is used for frying, with the salt microparticles mixed and suspended throughout the oil mixture.

FIG. 19 illustrates the suspendability of the micronized salt particles in the oil suspension, according to some embodiments of the invention, compared to prior art table salt that cannot be suspended in oil. In disclosed embodiments, the oil suspension of salt microparticles, prepared as disclosed herein by milling the salt particles within the oil suspension to reduce their size—may be prepared in relatively high concentration, and intermixed with frying oil of the same or different type— to yield the frying oil. The photos in FIG. 19 clearly show the initial pouring of the oil suspension of micronized salt particles into the frying oil and their consequent mixture (directly or supported by warming and/or gentle mechanical mixing) that yields a homogenous oil suspension of the micronized salt particles in which the food products are fried.

Furthermore, sedimentation experiments at different temperatures of disclosed oil suspension of the micronized salt particles used for frying (e.g., after mixing a concentrated suspension in additional frying oil) have shown that the homogenous suspension of the micronized salt particles in the oil is maintained from frying temperatures (170° C.) down to about 70° C.—indicating the stability of the suspension. Below 70° C. some of the larger micronized salt particles sediment, but can be re-suspended by heating the oil back to frying temperature, and optionally by applying gentle mixing.

FIGS. 20A-20C provide comparative results concerning various organoleptic characteristics of French fries prepared by the disclosed methods, according to some embodiments of the invention, compared with prior art French fries and alternative preparation methods. The frying experiments were carried out in small batches, each in oil at 170-185° C., with about 0.5 wt % salt (ca. 200 mg Na/100 gr fries), unless indicated otherwise. Salt concentration in disclosed fried food products was calculated with respect to the absorbed oil in the food products, as the micronized salt particles were evenly distributed throughout the suspension, according to the following formula, with C_{final} and Cₒᵢₗ indicating the salt concentration in the product and in the oil, respectively, and M denoting the mass of the respective—initial amount of oil, remaining amount of oil and of the prepared food product.

$${C}_{final} = \frac{( {M}_{oil initial} - {M}_{oil left} ) * {C}_{oil}}{{M}_{prepared sample}}$$

FIG. 20A illustrates a comparison between the prior art in which table salt is applied onto the fries after the frying, disclosed French fries that are fried in the oil suspension of the micronized salt particles, and French fries that were fried in oil and then the disclosed oil suspension of the micronized salt particles onto the fries. The results indicate that the main parameter that was improved using the disclosed oil suspension of the micronized salt particles was the saltiness of the fries (statistically significant). The enhanced saltiness may be utilized to reduce the amount of salt on the fries to achieve a similar saltiness level to the prior art—with less salt. Other organoleptic characteristics such as absence of off flavors, absence of oiliness and crispiness are similar or somewhat improved compared to the prior art. Applying the disclosed suspension onto the fries after frying provide partial improvements compared to carrying out the frying in the disclosed suspension itself.

FIG. 20B illustrates a comparison similar to FIG. 20A, but with reduced salt content in the disclosed oil suspension of the micronized salt particles resulting in half the amount of sodium, and compared to prior art fries. While prior art fries had 0.52 wt % salt (ca. 200 mg Na per 100 gr fries), disclosed fries with reduced sodium content had 0.26 wt % salt (ca. 100 mg Na per 100 gr fries). The results indicate that still, the disclosed oil suspension of the micronized salt particles with reduced amount of salt—is saltier than the prior art and hence allows for further sodium level reduction. Significant results are indicated by ***, and include, in addition to the higher saltiness, also reduced oiliness compared to the prior art and a more uniform salt distribution, probably due to the frying in the salt suspension providing more uniform salt distribution than applying table salt after frying (in the prior art the salt articles are much larger, and their adherence to the surface of the fries is much less uniform).

FIG. 20C illustrates a comparison between different types of oils used as the frying oil, into which the disclosed suspension with micronized salt particles (prepared with MCT oil) is mixed. MCT oil provides the best results with respect to saltiness and absence of off flavors, while sunflower oil provides enhanced saltiness and palm oil provides enhanced absence of off flavors.

Additional experiments included a comparison of potato crisps fried in the disclosed suspension with micronized salt particles compared to the prior art. The results indicated that the disclosed crisps had a lower oil content (reduced oiliness) by about 30% compared to the prior art and enhanced saltiness and/or reduced sodium content—as disclosed crisps with 180 mg Na per 100 gr crisps had the same saltiness level as prior art crisps with ca. 400 mg Na per 100 gr crisps.

Elements from FIGS. 1A-20C may be combined in any operable combination, and the illustration of certain elements in certain figures and not in others merely serves an explanatory purpose and is non-limiting.

In the above description, an embodiment is an example or implementation of the invention. The various appearances of “one embodiment”, “an embodiment”, “certain embodiments” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method of refining cocoa mass, the method comprising milling the cocoa mass to reduce a median particles size (D50 percentile) and break cells to release the cells content to the cocoa mass.

2. The method of claim 1, the method further comprising reducing bitterness and sourness, and enhancing smoothness and taste by the milling.

3. The method of claim 1, comprising melting the cocoa mass while milling.

4. The method of claim 1, wherein the cocoa mass does not include carrier oil.

5. The method of claim 1, further comprising adding at least one emulsifier to the cocoa mass.

6. The method of claim 1, further comprising adding edible solid particles to the cocoa mass prior to the milling.

7. The method of claim 6, wherein the edible solid particles comprise sugar.

8. The method of claim 1, wherein the median particles size (D50 percentile) is reduced below 6 μm.

9. Refined cocoa mass prepared by the method of claim 8, having a median particles size (D50 percentile) below 6 μm.

10. A suspension including micronized edible particles suspended in lipids, the suspension comprising at least 30 wt % micronized edible particles in the suspension, wherein the edible particles comprise any of: cocoa powder, white crystalline sugar, Demerara crystalline sugar, crystalline salt, spice particles, corn fibers, chicory root fibers, other fibers, rice flour, proteins, crystalline salt (NaCl), MSG (monosodium glutamate), oregano or other spices, coriander seeds, vanilla and cocoa.

11. The suspension of claim 10, wherein the micronized edible particles comprise at least 5 wt % sugar

12. The suspension of claim 10, wherein the lipids comprise at least one of: Cocoa butter, MCT oil, Ghee butter, palm oil, high olein palm oil, hazelnut paste, milk butter, milk fat, refined coconut oil, sunflower oil, canola oil and soy oil in liquid form or animal fats in molten liquid form.

13. The suspension of claim 10, further comprising at least one emulsifier.

14. A method of preparing a suspension of at least 30 wt % micronized edible particles suspended in lipids, the method comprising:
mixing edible particles in liquid lipids,
reducing particle sizes in a first coarse shearing step involving size-reducing mechanical interactions between the edible particles and a shearing device, and
micronizing the size-reduced edible particles suspended in the liquid lipids in a second fine milling step involving size-reducing mechanical interactions among the edible particles and/or between the edible particles and a milling device,
wherein the edible particles comprise any of cocoa powder, white crystalline sugar, Demerara crystalline sugar, crystalline salt, spice particles, corn fibers, chicory root fibers or any other fibers, rice flour, proteins, crystalline salt (NaCl), MSG, oregano or other spices, coriander seeds, vanilla and cocoa, wherein the edible particles are optionally associated with fat, and
wherein the liquid lipids comprise at least one of Cocoa butter, MCT oil, Ghee butter, palm oil, high olein palm oil, hazelnut paste, milk butter, refined coconut oil, sunflower oil, canola oil and soy oil—in liquid form or animal fats like tallow, lard, duck fat, chicken fat etc. in their molten liquid form.

15. The method of claim 14, wherein the micronized edible particles comprise at least 5 wt % sugar.

16. The method of claim 14, further comprising adding at least one processing aid to the suspension to lower the viscosity and/or to improve stability and homogeneity at the second fine milling step.

17. The method of claim 14, further comprising adding at least one emulsifier.

18. The method of claim 10, wherein the edible particles are optionally associated with fat.

19. The method of claim 12, wherein the animal fat is selected from the group consisting of tallow, lard, duck fat, chicken fat etc. in their molten liquid form.
